(19) United States
(12) Patent Application Publication
(10) Pub. No.: US 2016/0063630 A1
(43) Pub. Date: Mar. 3, 2016

(54) DYNAMICALLY UPDATING PREDICTION SYSTEM

(71) Applicant: Michael Peter MOLLOY, London (GB)

(72) Inventor: Michael Peter MOLLOY, London (GB)

(21) Appl. No.: 14/476,262

(22) Filed: Sep. 3, 2014

(51) Int. Cl. G06Q 40/06; G06F 3/0488; G06F 3/0485

(52) U.S. Cl. CPC G06Q 40/06; G06F 3/04883; G06F 3/0485

(57) ABSTRACT

Methods and systems are provided for dynamically updating a projected cash flow for an investment using a gesture-based graphical user interface. The method comprises displaying in the graphical user interface a graphical representation of the projected cash flow for an investment and performance metrics for the investment based on the projected cash flow; receiving gesture input from a user via the graphical user interface; updating the projected cash flow based on the gesture input; updating the performance metrics based on the updated projected cash flow; updating the graphical user interface to reflect the updates to the projected cash flow and the performance metrics.

### BACKGROUND

Cash flow modeling is the process of projecting the cash flow of an investment over a period of time (e.g. years) using a set of assumptions and relationships between items. The investment may be as simple as the purchase of a fixed income bond or as complex as the acquisition of a multi-billion dollar company.

Once a cash flow model has been produced it can be used to assess or evaluate the investment using generally accepted financial analysis methodologies such as IRR (Internal Rate of Return) which is the rate of growth an investment is expected to generate, or NPV (Net Present Value) which is the difference between the present value of the future cash flows from the investment and the amount of the investment. Generally, if the IRR is higher than the cost of capital then the investment is desirable. Similarly, if the NPV is positive then the investment is generally desirable.

The most popular method for cash flow modeling comprises generating a cash flow spreadsheet. This requires a user manually inputting the features of the investment, assumptions and relationships into a spreadsheet and appropriately linking them (e.g. via formulas etc.) to produce a projection of the cash flow of the investment over a predetermined period of time.

The manual input required to generate cash flow spreadsheets makes the spreadsheets and the cash flow models generated therefrom prone to human error. This may be, for example, because of the sheer volume of information that is required to be input into the spreadsheet or because the user does not have adequate levels of spreadsheet expertise (e.g. the user is not familiar with the spreadsheet tools and how to properly apply them). For example, generating a cash flow spreadsheet generally requires the knowledge and application of the correct spreadsheet libraries of ready-made formulas to accurately calculate the necessary basic components and timelines for any cash flow model. These include, for example, libraries and components for investment functions (e.g. Microsoft™ Excel™ functions IRR and XIRR), calendar and time functions and mathematical functions. These libraries and formulas are not always correctly identified and/or applied by the individual(s) generating the cash flow spreadsheet resulting in errors in the spreadsheet and model generated therefrom.

Generating a cash flow spreadsheet is also quite time consuming especially when built from scratch. Users may attempt to reduce the time to generate a cash flow spreadsheet by modifying an existing cash flow spreadsheet, which is commonly referred to as a “template”. However, depending on the skill level of the individual(s) completing the modification(s), the modification process can be prone to more errors than generating a cash flow spreadsheet from scratch. This is particularly true, where the modifier does not fully understand the relationship between the elements of the spreadsheets and their significance.

The embodiments described below are not limited to implementations which solve any or all of the disadvantages of known cash flow modeling systems.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are methods and systems for dynamically updating a projected cash flow for an investment using a gesture-based graphical user interface. The method comprises displaying in the graphical user interface a graphical representation of the projected cash flow for an investment and performance metrics for the investment based on the projected cash flow; receiving gesture input from a user via the graphical user interface; updating the projected cash flow based on the gesture input; updating the performance metrics based on the updated projected cash flow; and updating the graphical user interface to reflect the updates to the projected cash flow and the performance metrics.

A first aspect provides a dynamically updating prediction system, the system comprising a computing-based device comprising: a cash flow data object, the cash flow data object comprising one or more cash flow items forming an investment; a cash flow generation module in communication with the cash flow data object, the cash flow generation module configured to: generate a projected cash flow for the investment based on the cash flow data object; and generate one or more performance metrics for the investment based on the projected cash flow; and a visual controller module in communication with the cash flow generation module, the visual controller module configured to: generate a graphical representation of the projected cash flow and display the graphical representation of the projected cash flow in a graphical user interface; display the one or more performance metrics for the investment in the graphical user interface; receive a gesture input from the user via the graphical user interface; and provide the gesture input to the cash flow projection module; wherein the cash flow projection module is further configured to update the projected cash flow and the one or more performance metrics for the investment based on the gesture input.

A second aspect provides a computer-implemented method for dynamically updating a prediction, the method comprising: generating, at a computing-based device, a graphical representation of a projected cash flow of an investment over a period of time; generating, at the computing-based device, one or more performance metrics for the investment based on the projected cash flow; displaying the graphical representation of the projected cash flow and the one or more performance metrics in a graphical user interface; receiving gesture input from a user via the graphical user interface indicating an adjustment to the projected cash flow; dynamically adjusting, at the computing-based device, the projected cash flow based on the gesture input received from the user; dynamically adjusting, at the computing-based device, the one or more performance metrics based on the adjusted projected cash flow; and updating the graphical user interface to reflect the adjusted projected cash flow and the one or more performance metrics.

A third aspect provides a tangible computer-readable media with device-executable instructions that, when executed by a computing-based device, direct the computing-based device to perform steps comprising: generating a graphical representation of a projected cash flow of an investment over a period of time; generating one or more performance metrics for the investment based on the projected cash flow; displaying the graphical representation of the projected cash flow and the one or more performance metrics in a graphical user interface; receiving gesture input from a user via the graphical user interface indicating an adjustment to the projected cash flow; dynamically adjusting the projected cash flow based on the gesture input received from the user; dynamically adjusting the one or more performance metrics based on the adjusted projected cash flow; and updating the graphical user interface to reflect the adjusted projected cash flow and the adjusted one or more performance metrics.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a dynamically updating cash flow prediction system;

FIG. 2 is a block diagram of the cash flow projection engine of FIG. 1;

FIG. 3 is a message diagram illustrating the messages that are sent between the components of the cash flow projection engine of FIG. 2;

FIG. 4 is a schematic diagram of an example parent graphical user interface of FIG. 1;

FIG. 5 is a flow diagram of a method for operating the parent graphical user interface of FIG. 4;

FIG. 6 is a series of schematic diagrams of the parent graphical user interface of FIG. 4 illustrating the effect of a user making a pan gesture after selecting the first capital event panel;

FIG. 7 is a series of schematic diagrams of the parent graphical user interface of FIG. 4 illustrating the effect of a user making a pinch gesture in the cash flow panel;

FIG. 8 is a series of schematic diagrams of the parent graphical user interface of FIG. 4 further illustrating the effect of a user making a pinch gesture in the cash flow panel;

FIG. 9 is schematic diagram of the parent graphical user interface of FIG. 4 illustrating the effect of a user making a tap gesture in the cash flow panel;

FIG. 10 is a series of schematic diagrams of the parent graphical user interface of FIG. 4 illustrating the effect of a user making a pan gesture in a capital event panel after the debt value has been selected;

FIG. 11 is a schematic diagram of an example child graphical user interface of FIG. 1;

FIG. 12 is a flow diagram of a method of operating the child graphical user interface of FIG. 11;

FIG. 13 is a schematic diagram of the child graphical user interface of FIG. 11 after the user has selected to add an item;

FIG. 14 is a schematic diagram of the child graphical user interface of FIG. 13 after the user has selected to add a fixed income item;

FIG. 15 is a schematic diagram of the child graphical user interface of FIG. 11 when the projected cash flow has at least one cash flow item;

FIG. 16 is a schematic diagram of the child graphical user interface of FIG. 11 after the user has selected an existing cash flow item;

FIG. 17 is a schematic diagram of the child graphical user interface of FIG. 16 after the user has performed a subsequent tap gesture on the selected cash flow item; and

FIG. 18 is a block diagram of an example end-user computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Embodiments described herein relate to methods and systems for generating and dynamically updating the projected cash flow of an investment using a touch or gesture-based graphical user interface. The term “investment” is used herein to mean putting money toward an asset or item anticipated to generate income or appreciate. An investment may relate to only a single asset or item or a plurality of assets or items (e.g. a portfolio). For example, an investment may be the purchase of shares in a company or the purchase of the company itself (which includes all of the company's investments). The terms “projected” and “predicted” are used interchangeably herein to mean a future estimate.

The graphical user interface described herein provides the user with a graphical representation of the projected cash flow of the investment over a predetermined period of time and allows the user to quickly and easily edit the projected cash flow using touch and/or other gestures. The term “gesture” is used herein to mean movement by the user or by an object (e.g. stylus) controlled by the user. Gestures include touch gestures and in-air gestures. Touch gestures are movements performed while the user or object, or part thereof, is in contact with a surface, such as a touchscreen. In contrast, in-air gestures are movements performed while the user or object is not in contact with a surface (e.g. the gestures are performed in free air).

In some cases the graphical representation of the projected cash flow shown to the user via the graphical user interface may be automatically updated to reflect and show any changes to the projected cash flow caused by touch and/or other gestures performed by the user. This allows the user to immediately see the effects of changes to the cash flow to determine, for example, whether to build a more detailed cash flow model via a cash flow spreadsheet.

In some cases the projected cash flow can also be converted into an equivalent cash flow spreadsheet for further manipulation and examination. This allows the user to generate a full-fledged cash flow spreadsheet that works with full internal integrity and self-referencing formula logic. Once generated, the cash flow spreadsheet is not reliant on the graphical user interface in which it was created and looks like it was generated by a top financial expert from scratch.

Allowing users to dynamically generate and update the projected cash flow of an investment using a touch or gesture based graphical user interface significantly reduces the amount of time for a user to project the cash flow of an investment. For example, in some cases, where it may take an expert user several hours to generate the projected cash flow for an investment, it may only take a user minutes to generate the projected cash flow for the same investment. This increases productivity while at the same time decreases risks since it automates many tasks and ensures the correct formulas and formatting are used for the right tasks.

In some cases the graphical user-interface is designed to be controlled based on touch or other gestures that are known and intuitive to smart phone or tablet users. For example, the graphical user-interface may be designed to be controlled at either end by the user's thumbs when the end-user computing-based device is being held in the user's hand in much the same way that the user would hold and interact with the end-user computing-based device for text messaging or gaming. This makes the graphical user interface very intuitive and user friendly.

Furthermore, since a touch or gesture based graphical user interface can easily be run on a small portable computing-based device, such as a smart phone or a tablet, cash flow projections can be built easily on the fly anywhere (e.g. on the bus, subway etc.) anytime. It also provides an easy platform to share and edit projected cash flows. For example, a smart phone or tablet can easily be hooked up to Audio/Visual (NV) equipment to display the projected cash flow (and/or the assumptions the projected cash flow is based on) to senior management or clients. Furthermore the gesture-based graphical user interface allows a user to easily make changes to the projected cash flow on the fly without having to scroll across many tabs and columns in a spreadsheet as with the cash flow spreadsheet method.

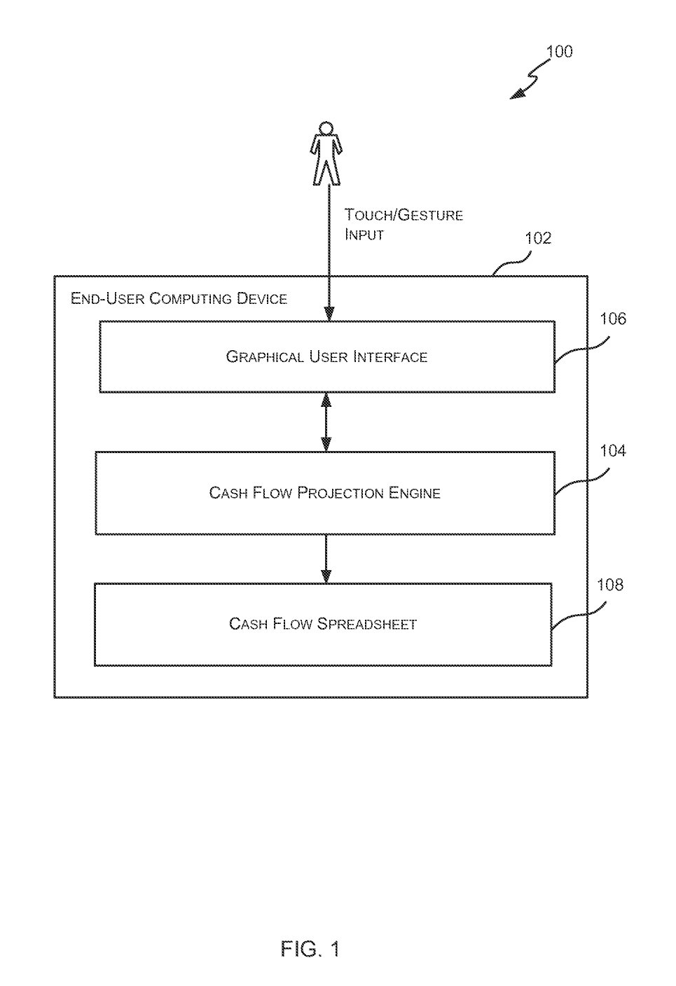

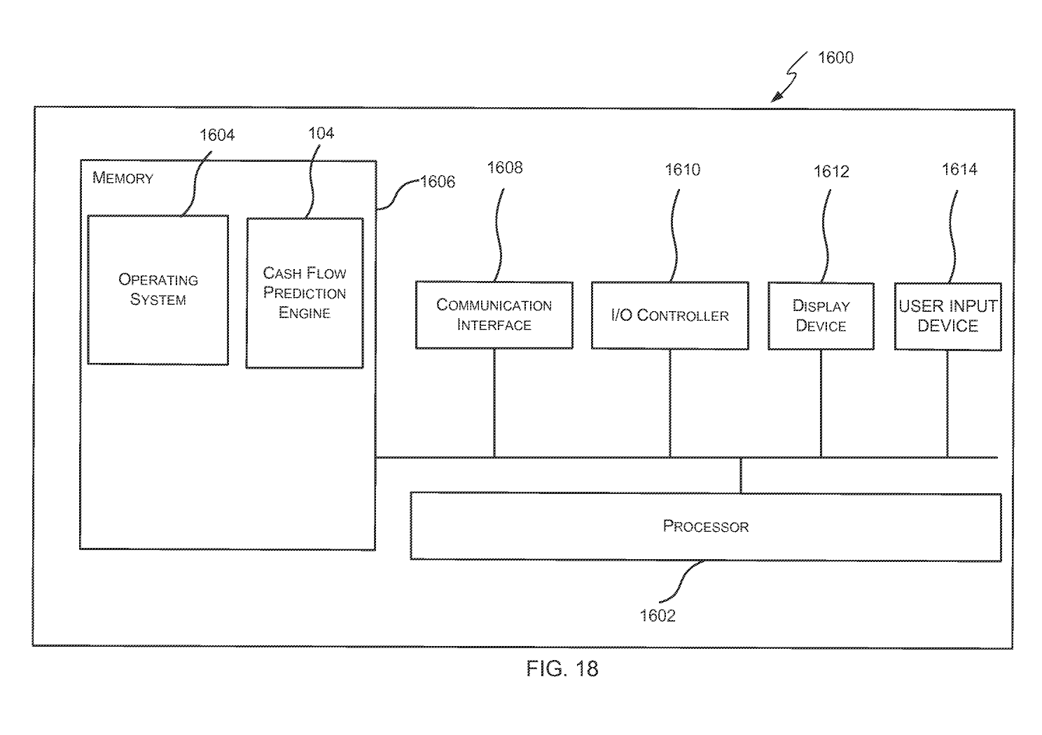

Reference is now made to FIG. 1 which illustrates an example system 100 for generating and dynamically updating a projected cash flow of an investment from a touch or other gesture based graphical user interface. The system 100 comprises an end-user computing-based device 102 that runs a cash flow projection engine 104. The end-user computing-based device 102 is any computing device that is capable of running the cash flow projection engine 104, displaying a graphical user interface, and receiving gesture (e.g. touch gesture) inputs from a user. The end-user computing-based device 102 may be, for example, a smart phone, a tablet computer, or another computing-based device with a touchscreen interface. However, other suitable computing-based devices may also be used. An example computing-based device is described with reference to FIG. 18.

The cash flow projection engine 104 generates and controls a graphical user interface 106 that allows a user to create and dynamically update a cash flow projection using touch and/or other gestures. In some cases the cash flow projection engine 104 is configured to visually display, in the graphical user interface 106, a graphical representation of the projected cash flow for an investment. The user can then adjust the projected cash flow and/or the investment via the graphical user interface 106 using touch and/or other gestures.

The cash flow projection engine 104 may be configured to automatically update the graphical representation of the projected cash flow of the investment that is displayed in graphical user interface 106 to reflect any changes made to the projected cash flow. This allows users to visually see the effect of any changes to the projected cash flow.

In some cases the cash flow projection engine 104 is also configured to display one or more performance metrics, such as IRR, for the investment based on the projected cash flow. The performance metrics may also be automatically updated to reflect any changes made to the projected cash flow. Accordingly, rather than building a detailed cash flow model from the ground up to explore sensitivity scenarios at the end of the model-building exercise, the cash flow projection engine 104 allows the user to observe sensitivity from the outset and at any time while adding complexity to the projected cash flow.

The term “sensitivity analysis” is used herein to mean changing one or more assumptions of the projected flow to see the change in a performance metric to determine how sensitive the performance metric (e.g. IRR) is to that particular assumption. Most assumptions involve an element of estimation. How sensitive a performance metric is to a particular assumption can indicate the margin of error that there can be in the estimate for the assumption before the performance metric no longer indicates the investment is viable. For example, if a proposed bid price is $95 million, an investment team may wish to see the change in IRR for each increment of $1 million in the purchase price from $90 million to $100 million to determine the sensitivity of IRR to purchase price.

In some cases, the cash flow projection engine 104 may also be capable of converting the projected cash flow generated and adjusted via the graphical user interface 106 into a cash flow spreadsheet 108 that looks and feels as if was generated from scratch by an individual or team with expertise in generating cash flow spreadsheets. The user may have the ability to initiate generation of such a cash flow spreadsheet at any point during the cash flow projection process.

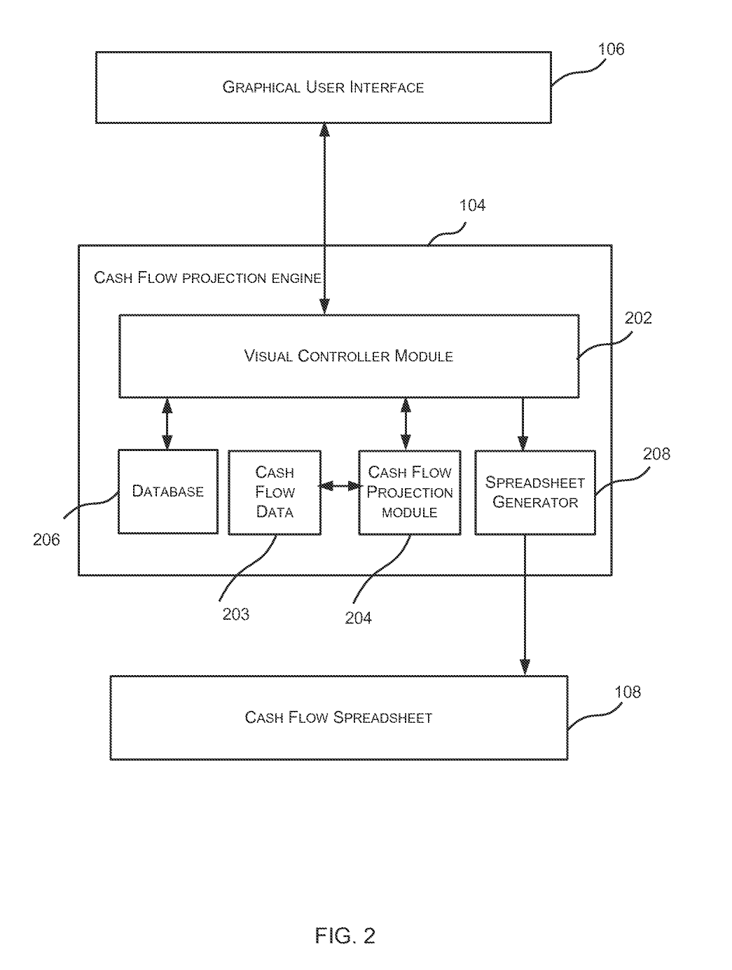

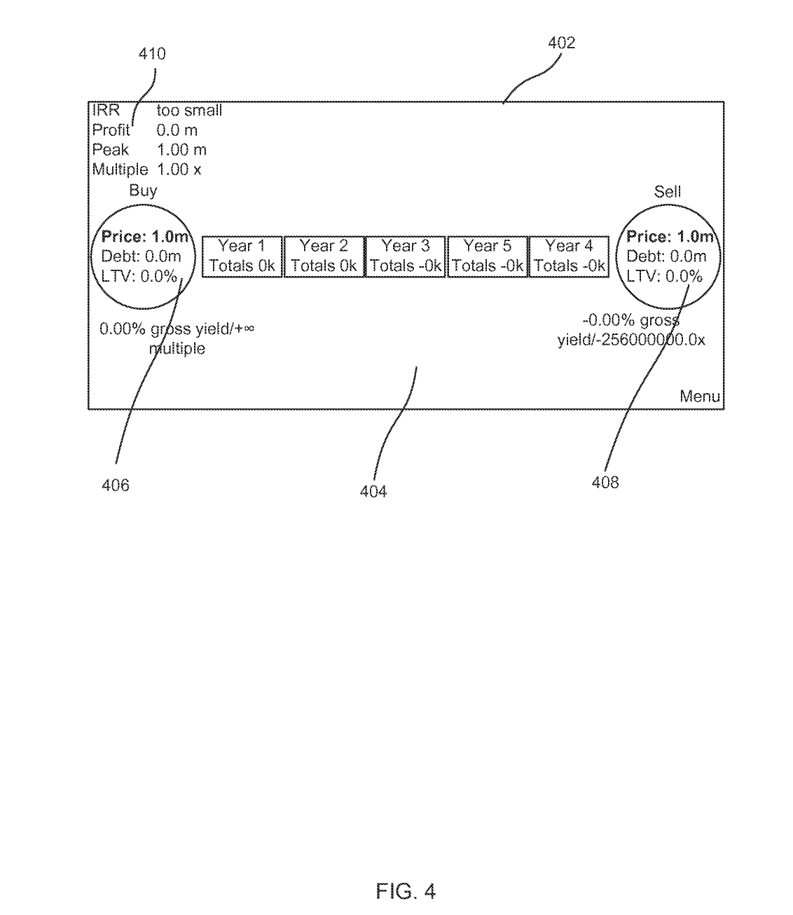

Reference is now made to FIG. 2 which illustrates an example block diagram of the cash flow projection engine 104 of FIG. 1. As described above, the cash flow projection engine 104 generates and controls a graphical user interface 106 that can receive touch and/or other gesture input from a user to allow the user to generate and/or update the projected cash flow of an investment. As described above, an investment may relate to a single asset or a plurality of assets (e.g. a portfolio). An example graphical user interface 106 will be described with reference to FIGS. 4 to 17.

In some cases the graphical user interface 106 is configured to graphically display the projected cash flow for a specific period of time (e.g. the hold period). For example, the graphical user interface 106 may be configured to display a bar graph of the projected cash flow of the investment over the specific period of time. The user can interact with the graphical user interface 106 using touch and/or other gestures to adjust/modify the projected cash flow (e.g. by adding, removing, and editing individual cash flow items and/or features/assumptions).

The cash flow projection engine 104 receives touch and/or other gestures from the graphical user interface 106 and updates the projected cash flow accordingly. In the example of FIG. 1, the cash flow projection engine 104 comprises a visual controller module 202, cash flow data 203 and a cash flow projection module 204.

The cash flow data 203 comprises all of the elements that make up the current projected cash flow. For example the cash flow data 203 may comprise a plurality of cash flow items forming the investment, the current assumptions for each cash flow item and the relationships between the items. Where the investment relates to a portfolio of assets as opposed to just one asset, the cash flow data may be grouped by the asset to which it relates. For example, where an investment relates to two assets, the cash flow data 203 may comprise cash flow data related to the first asset and cash flow data related to the second asset.

The term “cash flow item” is used herein to mean a cash inflow or cash outflow with a discernible pattern over the time of an investment and defined by a set of industry-recognized characteristics. In some cases the cash flow items may be categorized into one of the following categories: (1) general and non-industry specific income items which includes, but is not limited to, fixed income, patterned income, miscellaneous annual income, and index-linked income; (2) expense items, which includes, but is not limited to miscellaneous expense annual items, fixed expense/overhead items per month with the option to allocate a percentage of the overhead against other income items; (3) debt facility which include, but is not limited to senior debt, mezzanine debt, development-loan-to-investment-loan items; and (4) capital expenditures which include, but are not limited to, capex project items with s-curve distributions over periods of time for significant cash outlays during construction, for example.

Each cash flow item has one or more assumptions associated therewith which define the cash flow item and describe its behavior. Example assumptions include, but are not limited to, start date and expiry date.

More complicated cash flow items may have more assumptions associated therewith. For example a debt facility cash flow item may have the following assumptions: start date, expiry date, interest cost per annum, amortization per annum, and an ICR covenant level options.

Some cash flow items will be defined by their relationship with other cash flow items. For example there may be a leasing costs cash flow item that may represent the relationship of other types of cash flow items in the investment. For example leasing costs may apply on the start date of any new lease cash flow item and may be a percentage of the starting rental payment per annum.

The cash flow projection module 204 is responsible for generating and updating the projected cash flow based on the cash flow data 203.

The visual controller module 202 acts as an intermediary between the graphical user interface 106 and the cash flow projection module 204. In particular the visual controller module 202 translates the touch and/or other gestures received by the graphical user interface 106 into commands to update/edit the projected cash flow which are implemented by the cash flow projection module 204. The visual control model 202 then converts any changes to the projected cash flow implemented by the cash flow projection module 204 into changes to the graphical user interface 106.

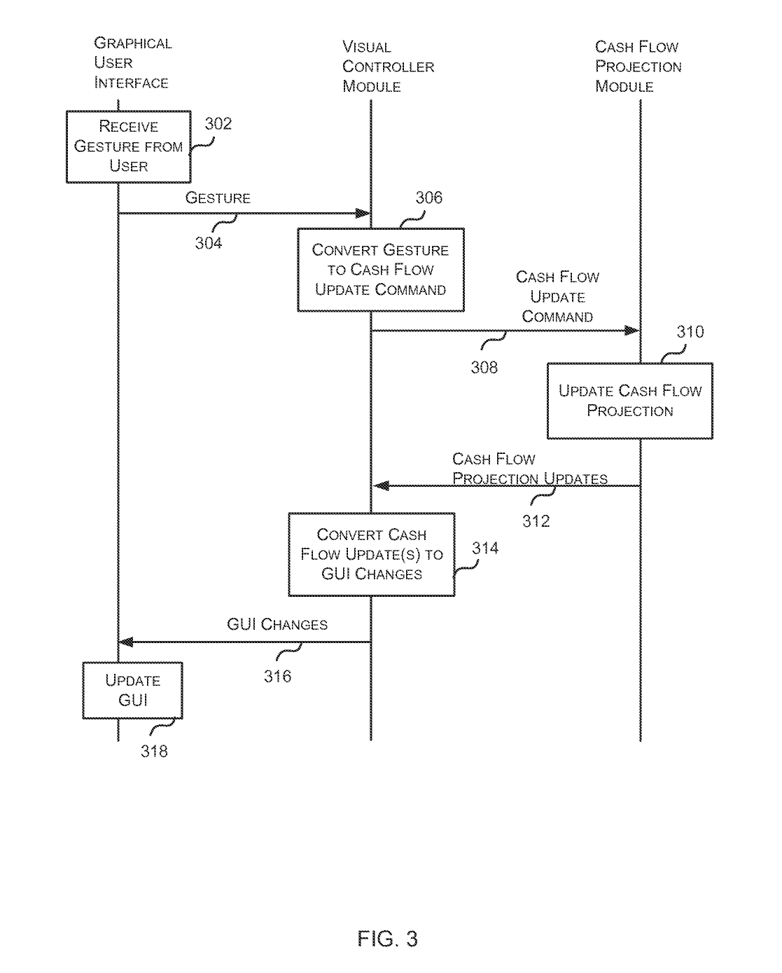

This is explained in more detail in reference to FIG. 3. In particular, the graphical user interface 106 receives a touch and/or other gesture from the user 302. The graphical user interface 106 then provides the gesture 304 along with the current state of the graphical user interface 106 to the visual controller module 202. The visual controller module 202 analyzes the touch and/or other gesture and the state of the graphical user interface 106 and generates a corresponding command to adjust or alter the projected cash flow 306. The command may specify what element or item of the projected cash flow is to be adjusted and what the adjustment is. For example, the user may make an upwards pan gesture in the graphical user interface 106 while the capital buy price of an investment is selected. The visual controller module 202, upon receiving the gesture from the graphical user interface and the state of the graphical user interface (e.g. that the capital buy price is selected), may generate a command to increase the buy price by a certain amount (based on, for example, the length, speed and number of times the pan gesture was executed).

Once the command has been generated by the visual controller module 202 it is sent 308 to the cash flow projection module 204. Upon receiving the command the cash flow projection module 204 adjusts or edits the projected cash flow and the cash flow data 203 accordingly 310. The cash flow projection module 204 then sends the visual controller module 202 a summary of the changes that have been made to the projected cash flow 312. In some cases the cash flow projection module 204 may also update any performance metrics based on the updated projected cash flow and send updated performance metric data to the visual controller module 202.

Upon receiving the summary of the changes to the projected cash flow the visual controller module 202 converts 314 the changes to the projected cash flow to updates to the graphical user interface 106. The visual controller module 202 then sends 316 the updates to the graphical user interface 106 where they are implemented or displayed 318. Similarly, where the visual controller module 202 also receives updated performance metric data it may also generate updates to the graphical user interface 106 to reflect the updated performance metric data.

Referring back to FIG. 2, the cash flow projection engine 104 may also comprise (as shown in FIG. 2) or have access to a database 206 which is used to store one or more cash flow data instances. This allows the user to save and then later retrieve a projected cash flow projection that they have built and/or edited. The visual controller module 202 may trigger the saving of the current or active cash flow data 203 to the database 206 upon receiving a particular touch and/or gesture from the graphical user interface 106. For example, the visual controller module 202 may trigger the saving of the current or active projected cash flow to the database 206 when the visual controller module 202 receives an indication from the graphical user interface 106 that the user has executed a tap gesture on a save or ok button. Upon receiving such an indication the visual controller module 202 may cause the cash flow projection module 204 to obtain the cash flow data 203 and forward it to the database 206 via the visual controller module 202.

The cash flow projection engine 104 may also comprise a spreadsheet generator 208 which is used to generate a cash flow spreadsheet from the projected cash flow. The spreadsheet generator 208 may be triggered by the visual controller module 202 upon receiving a particular touch and/or other gesture from the graphical user interface 106. For example, the visual controller module 202 may trigger the generation of a cash flow spreadsheet when the visual controller module 202 receives an indication from the graphical user interface 106 that the user has executed a tap gesture on an export button. Upon receiving such an indication the visual controller module 202 may request all the information for the current projected cash flow from the cash flow projection module 204 and forward this information to the spreadsheet generator 208 with a request to generate a cash flow spreadsheet from the attached information.

The spreadsheet generator 208 may be configured to write both the formula used to calculate a cell's value, and a cell value to the generated spreadsheet. The cell value is the value that would have been the last saved or calculated value for the respective cell formula had the projected cash flow been originally generated in a spreadsheet. If only the formula is saved then the values of the cells will initially be empty requiring the user to perform a refresh of all fields when they open the spreadsheet.

In particular, the spreadsheet generator 208 will often attempt to implement a single short formula that is repeated across each row. For example the spreadsheet generator 208 may paste the date formula=DATE(YEAR(R[−1]C), MONTH(R[−1]C)+1,DAY(R[−1]C)−1) in a set of consecutive cells in a row so that each cell has a date value that is one month later than the date value in the previous cell in that row.

In addition to pasting this formula in each relevant cell, the spreadsheet generator 208 also writes the date value for each of those cells. For example, the cell in column 14 will have the same formula as the other cells in the same row, but it will have a unique date value: “2014-08-11T19:19:38”.

This may, for example, be implemented using the following XML Excel™ file format, or any other spreadsheet file format structure.

<Row>
<Cell ss:Index=“10” ss:StyleID=“normal_format_left_#808080”><Data
ss:Type=“String”>End of period</Data></Cell>
<Cell ss:Index=“12” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-06-11T19:19:38</Data></Cell>
<Cell ss:Index=“13” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-07-11T19:19:38</Data></Cell>
<Cell ss:Index=“14” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-08-11T19:19:38</Data></Cell>
<Cell ss:Index=“15” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-09-11T19:19:38</Data></Cell>
<Cell ss:Index=“16” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-10-11T19:19:38</Data></Cell>
<Cell ss:Index=“17” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-11-11T19:19:38</Data></Cell>
<Cell ss:Index=“18” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2014-12-11T19:19:38</Data></Cell>
<Cell ss:Index=“19” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2015-01-11T19:19:38</Data></Cell>
<Cell ss:Index=“20” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2015-02-11T19:19:38</Data></Cell>
<Cell ss:Index=“21” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2015-03-11T19:19:38</Data></Cell>
<Cell ss:Index=“22” ss:StyleID=“day_date_right_#808080”
ss:Formula=“=DATE(YEAR(R[−1]C),MONTH(R[−1]C)+1,DAY(R[−1]C)−
1)”><Data ss:Type=“DateTime”>2015-04-
11T19:19:38</Data></Cell>.................etc.

Where <Row> indicates the start of a row's information in a file; <Cell is where the information is written describing a cell's attributes such as font format, colour, style and formula etc.; <Data ss:Type=“Number”? 1234</Data> is the last calculated value that is shown in a cell; </Cell> indicates the end of the respective cell information; </Row> indicates the end of the respective row information.

Since the formula, data value and formatting information is stored in the file, the resulting spreadsheet may look like that shown in Table 1.

TABLE 1

| | | | | | | | | | | | | | |
|---|---|---|---|---|---|---|---|---|---|---|---|---|---|
| Year | 2,014 | 2,014 | 2,014 | 2,014 | 2,014 | 2,014 | 2,014 | 2,014 | 2,015 | 2,015 | 2,015 | 2,015 | 2,015 |
| Start of Period | 12-May | 12-Jun | 12-Jul | 12-Aug | 12-Sep | 12-Oct | 12-Nov | 12-Dec | 12-Jan | 12-Feb | 12-Mar | 12-Apr | 12-May |
| End of Period | 11-Jun | 11-Jul | 11-Aug | 11-Sep | 11-Oct | 11-Nov | 11-Dec | 11-Jan | 11-Feb | 11-Mar | 11-Apr | 11-May | 11-Jun |
| Number of days | 30 | 30 | 31 | 31 | 30 | 31 | 30 | 31 | 31 | 28 | 31 | 30 | 31 |
| Month | 1 | 2 | 3 | 4 | 5 | 6 | 7 | 8 | 9 | 10 | 11 | 12 | 13 |

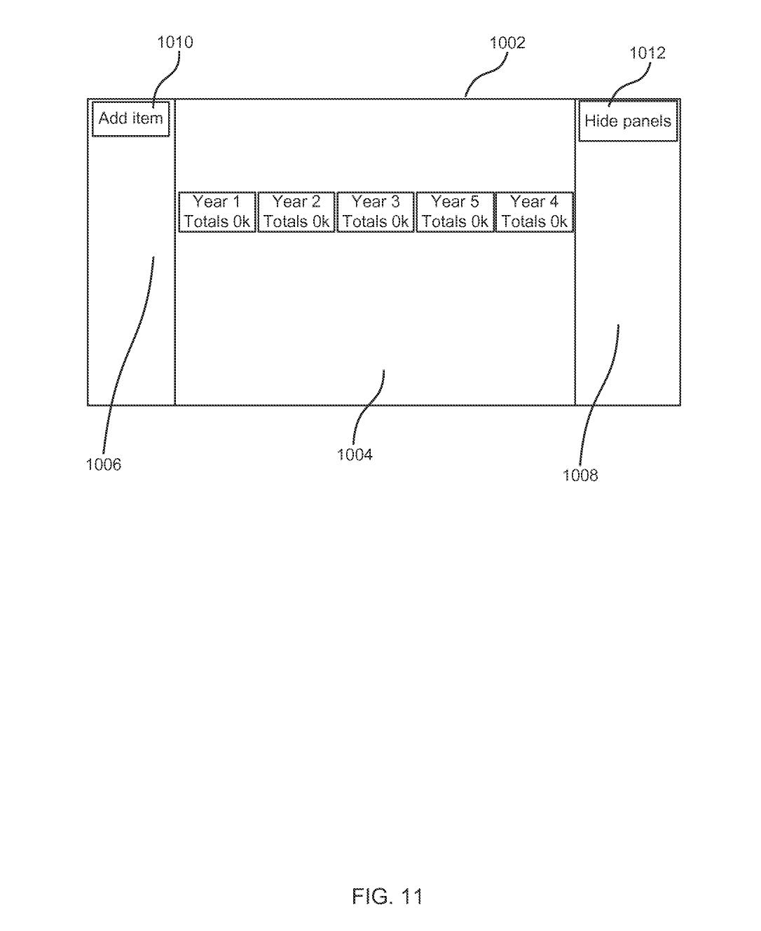

In some cases the graphical user interface 106 comprises two parts—a parent graphical user interface and a child graphical user interface. The parent graphical user interface is the main or default graphical user interface and is used to provide a graphical representation of the projected cash flow over the specified time period. The child graphical user interface is used to provide additional or secondary functionality to the main or parent graphical user interface and thus the child graphical user interface may only be displayed after the user has executed a specific gesture or set of gestures on the main or parent graphical user interface indicating they wish to access the additional or secondary functionality. An example parent graphical user interface will be described with reference to FIGS. 4 to 10 and an example child graphical user interface will be described with reference to FIGS. 11 to 17.

Reference is now made to FIG. 4 which illustrates an example parent graphical user interface 402. The example parent graphical user interface 402 is divided into four sections or panels—a main panel 404, a first capital event panel 406, a second capital event panel 408 and a performance metric panel 410. The main panel 404 is referred to as the cash flow panel as it is used to display a graphical representation of the projected cash flow of the investment for a specified period of time. In some cases the specified period of time is the time between the first capital event (e.g. the date the investment is started) and the second capital event (e.g. the date the investment is exited). The specified period of time will be referred to herein as the hold period or the life of the investment.

In some cases, as shown in FIG. 4, the first capital event is a buy event (e.g. the purchase of an asset or investment) and the second capital event is a sell event (e.g. the sale of an asset or investment). In other cases, the first capital event is a sale event and the second capital event is a purchase event.

As shown in FIG. 4, the graphical representation of the cash flow may be a bar graph illustrating the projected cash flow per sub-period of the hold period. For example, in FIG. 4, the cash flow panel 404 displays the projected cash flow of the investment for each year of the hold period. Each sub-period (e.g. year) may be further divided into smaller portions. For example, where the sub-period is a year, each year may be further divided into quarter portions. It will be evident to a person of skill in the art that other graphs may be used to represent or display the cash flow and that other sub-periods and/or portions thereof may also be used. For example, in other examples the hold period may be divided into other sub-periods (e.g. a sub-period other than one year) and not all of the sub-periods have to be the same duration (e.g. some of the sub-periods may be months whereas others may be quarters or years).

The first capital event panel 406 displays capital assumptions at the time of the first capital event. For example, where the first capital event is a buy event, the first capital event panel 406 may display the purchase price of the investment, the debt assumed to purchase the investment and the LTV (Loan to Value) ratio (i.e. the ratio of price to debt). It will be evident that the capital assumptions displayed in the first capital event panel 406 of FIG. 4 are exemplary and additional or other assumptions may be displayed.

In some cases, as shown in FIG. 4, additional information about the first capital event may be displayed below the first capital event panel 406, such as, but not limited to, gross/net yield and income multipliers.

The second capital event panel 408, similar to the first capital event panel 406, is used to display capital assumptions about the sale of the investment. For example, the second capital event panel 408 may display the sale price of the investment, the debt assumed for the sale, and the LTV. It will be evident to the person of skill in the art that the information displayed in the second capital event panel 408 of FIG. 4 is exemplary and additional or other information may be displayed.

In some cases, as shown in FIG. 4, additional information about the second capital event may be displayed below the second capital event panel 408, such as, but not limited to, gross/net yield and income multipliers.

The performance metric panel 410 is used to display one or more performance metrics. Each performance metric provides a quantitative measure of the quality of the investment. For example, the information panel may display the following performance metrics: IRR (Internal Rate of Return), profit, peak and/or multiple values.

As is known to those of skill in the art the IRR is the discount factor that makes the total projected cash flow inflows and outflows over the life of the investment equal zero. For example if the initial purchase price is $1.00 and the sell price is $1.10 after a year, the IRR is 10% because−$1.00+($1.10/(1+IRR))=0. The profit is the sum of all net investment cash inflows and outflows. The peak or peak equity is the maximum accumulative net cash flow outlay the investor needs to commit by way of an equity drawdown/call. The multiple or equity multiple is defined as (peak equity+profit)/peak equity.

It will be evident to a person of skill in the art that these performance metrics are examples only and that other performance metrics may alternatively or in addition be displayed in the performance metric panel 410. For example, in some cases the performance metric panel 410 may be configured to also display the NPV (Net Present Value) and/or the current discount rate being applied to calculate the NPV.

In some cases information on annual yield calculations may also be displayed in the parent graphical user interface (not shown). For example, the parent graphical user interface may be configured to display one or more of Net Operating Income (NOI) yields; Interest Coverage Ratios (ICRs) or Debt Service Coverage Ratios (DSCRs) per sub-period (e.g. year) for each sub-period (e.g. year) of the hold period. In some cases, a particular ICR label may be highlighted (e.g. in red) to indicate that a certain ICR covenant is breached in any year of the projected cash flow.

For example, where the hold period is 5 years and the sub-periods are years, the following may be displayed in the parent graphical user interface: “ICR: 1.7×, 1.7×, 1.5×, 1.5×, 1.3×”. Where the ICR covenant is 1.5 per year then the “1.3×” may be highlighted (e.g. in red) to indicate the convent has been breached in year 5.

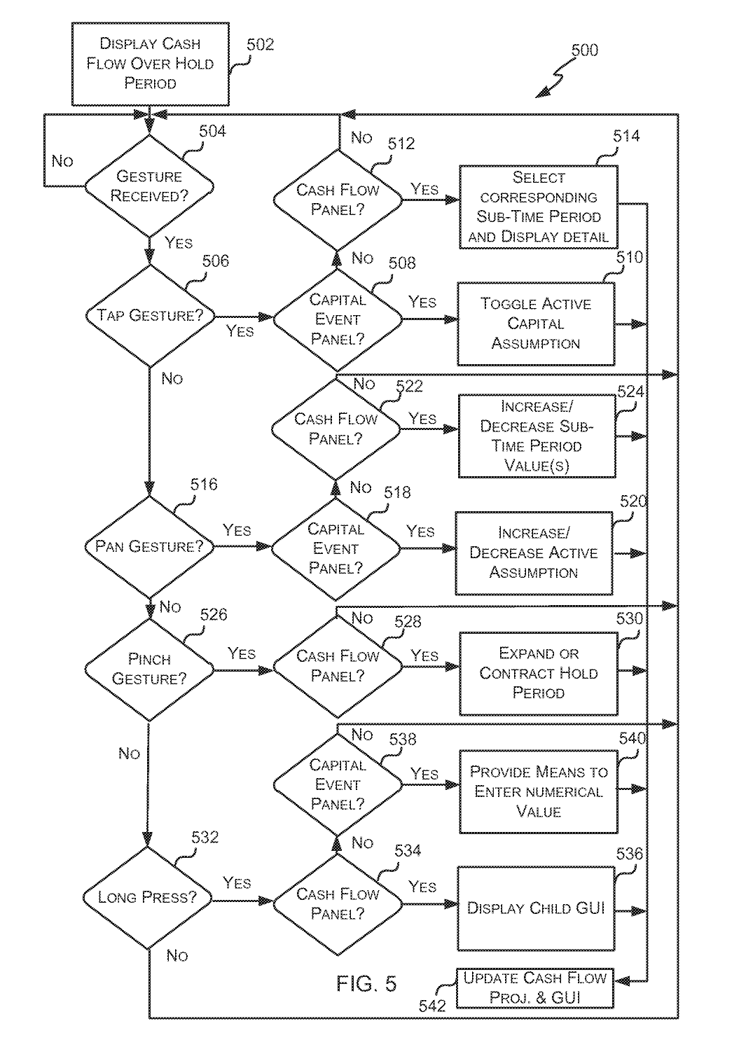

Reference is now made to FIG. 5 which illustrates a method 500 for operating the parent graphical user interface 402 of FIG. 4. In particular, method 500 illustrates an example of what gestures may be used in the parent graphical interface 402 to invoke changes to the projected cash flow. In this example, the parent graphical user interface 402 accepts tap, pan, pinch and press and hold touch gestures, however, it will be evident to a person of skill in the art that these are examples only and other suitable gestures may be used alternatively or in addition.

At block 502, the projected cash flow of the investment over a particular time period (e.g. hold period) is shown in the parent graphical user interface 402. In some cases, when the cash flow projection engine 104 is started the parent graphical user interface 402 may display the projected cash flow for the investment that the user was previously working on, or alternatively, the projected cash flow for a default or null investment. In other cases the user may be given the option of selecting a saved investment or generating a new investment. Once the projected cash flow has been displayed for the current or active investment, the method 500 proceeds to block 504.

At block 504, the parent graphical user interface 402 waits for the user to perform a touch and/or other gesture. Once the parent graphical user interface 402 has detected the user has performed a touch and/or other gesture, the method 500 proceeds to block 506.

At block 506, it is determined whether the detected gesture is a tap gesture. The term “tap gesture” is used herein to mean that the user has pressed or tapped on a portion of the input device (e.g. touchscreen) once and then removed their finger (or other gesture making object, such as a stylus) from the input device. If the detected gesture has been identified as a tap gesture, the method proceeds to block 508. If, however, the detected gesture was not identified as a tap gesture, the method 500 proceeds to block 516.

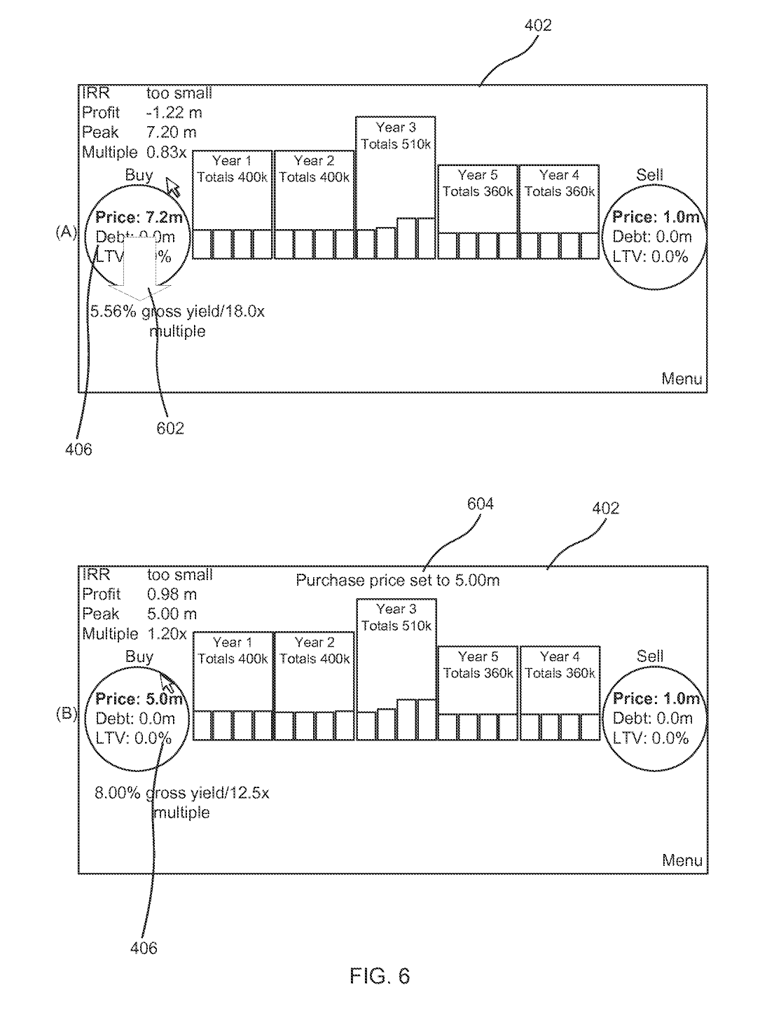

At block 508, it is determined whether the detected tap gesture was performed in a capital event panel (e.g. first capital event panel 406 or second capital event panel 408). If it is determined that the detected tap gesture was performed in a capital event panel 406 or 408 then the method 500 proceeds to block 510 where the next non-active or non-selected capital assumption (price, debt, LTV) in the capital event panel is selected or activated. This allows the user to easily toggle between the capital assumptions in a capital event panel by tapping on the capital event panel. Once a capital assumption has been selected or activated the user can adjust the associated value by making a panning gesture in the capital event panel. This will be described in more detail below in reference to FIG. 6. Once the next capital event has been selected or activated, the method 500 proceeds to block 542 where the projected cash flow, performance metrics and the parent graphical user interface 402 are updated accordingly.

At block 512, it is determined whether the detected tap gesture was performed in the cash flow panel 404. If it is determined that the detected tap gesture was performed in the cash flow panel 404 then the method 500 proceeds to block 514 where the sub-period (e.g. year) corresponding to the location of the tap is selected or activated and additional information related to the selected sub-period is displayed. A subsequent tap in the same sub-period (e.g. year) may allow the user to individually select or activate portions (e.g. quarters) of the sub-period (e.g. year).

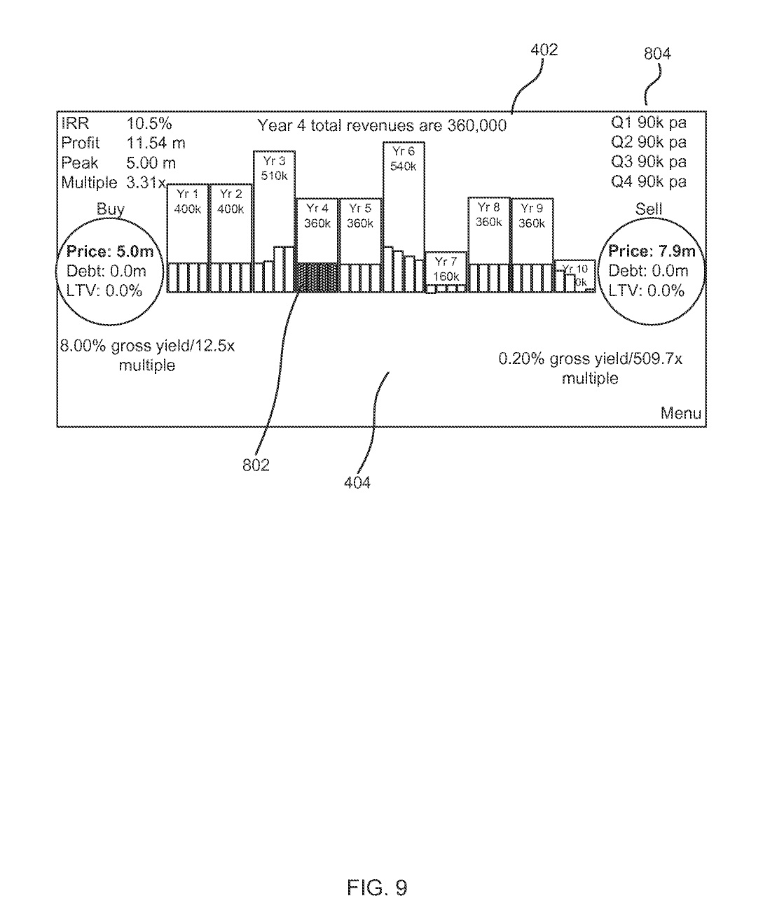

An example of performing a tap gesture in the cash flow panel 404 is shown in FIG. 9. In particular, FIG. 9 shows the parent graphical user interface 402 after the user has executed a tap gesture in the year four sub-period 802 is shown in FIG. 9. As a result of the tap gesture, the year four sub-period is selected or highlighted and additional information 804 about the selected sub-period (e.g. year four) is displayed. As shown in FIG. 9, the additional information 804 may, for example, comprise values for each portion (e.g. quarter) of the selected year. The method 500 then proceeds to block 542 where the projected cash flow, performance metrics and the parent graphical user interface 402 are updated accordingly.

At block 516, it is determined whether the detected gesture is a pan gesture. The term “pan gesture” is used herein to mean that the user has placed their finger (or other gesture making object, such as a stylus) on the input device and moved their finger (other gesture making object) from one point to another while in contact with the input device. If the detected gesture has been identified as a pan gesture, the method proceeds to block 518. If, however, the detected gesture was not identified as a pan gesture, the method proceeds to block 526.

At block 518, it is determined whether the pan gesture was performed in a capital event panel (e.g. first capital event panel 406 or second capital event panel 408). If it is determined that the detected pan gesture was performed in a capital event panel 406 or 408 then the method 500 proceeds to block 520 where the currently selected or active capital assumption (price, debt, LTV) is increased or decreased based on the direction of the pan gesture. For example, in some cases, when the user makes an upward pan gesture (e.g. towards the top of the parent graphical user interface 402) the capital assumption is increased; and when the user makes a downward pan gesture (e.g. towards the bottom of the parent graphical user interface 402) the capital assumption is decreased. The amount of the increase or decrease may be based on the speed of the pan gesture (e.g. how quickly the user has moved their finger); the amount of the pan gesture (e.g. how far the user has moved their finger); and/or how many times the user performs the gesture.

An example of a parent graphical user interface 402 after a pan gesture has been executed in a capital even panel is shown in FIG. 6. In particular, FIG. 6A shows that the price capital assumption in the buy capital event panel 406 has been selected or activated. When the user performs a downward pan gesture 602 in the first capital event panel 406 when the parent graphical user interface 402 is in this mode, the price value is decreased from 7.2 m (FIG. 6A) to 5.0 m (FIG. 6B). If a gesture has caused a change to the projected cash flow and/or investment then the parent graphical user interface 402 may be updated with a message 604 that indicates what has been changed or updated. For example, in FIG. 6B a message 604 is displayed indicating that the purchase price was set to 5.00 m. In some cases, instead of, or in addition to displaying a message (e.g. message 604) after the user has completed a change to a capital event assumption (e.g. after completing a pan gesture), a message may be displayed as soon as the user starts the gesture (e.g. pan gesture) which is continuously updated as the user is making the gesture.

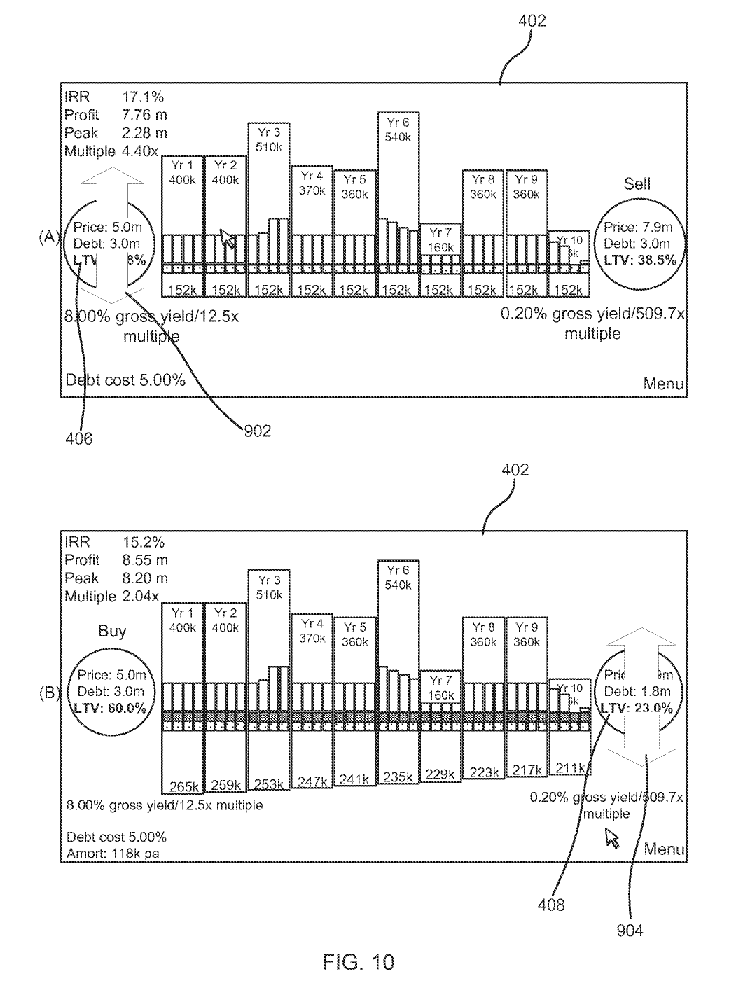

Another example of a parent graphical user interface 402 after a pan gesture has been executed in a capital event panel is shown in FIG. 10. In particular, FIG. 1 OA illustrates the effect of executing a pan gesture 902 in the first capital event panel 406 while the LTV assumption is selected. Such a gesture causes the LTV value to be adjusted. In particular, an upwards pan gesture (a pan gesture made towards the top of the parent graphical user interface 402) may increase the day one (e.g. buy date) LTV that is applied to the purchase price and a downward pan gesture (a pan gesture made towards the bottom of the parent graphical user interface 402) may decrease the day one (e.g. buy date) LTV).

If there are various debt facilities, in some cases the default may be to change the senior debt. In other cases the default may be to change the debt facility that was most recently selected in the child graphical user interface. As will be described below, the child graphical user interface allows the user to view and edit the cash flow items of the projected cash flow, such as debt facilities. Accordingly, if the mezzanine debt was the most recently selected debt in the child graphical user interface when the user returns to the parent graphical user interface then if the user subsequently adjusts the LTV through a pan gesture this may adjust the LTV % associated to the mezzanine debt of the overall debt capital structure. For example, if senior debt is already at 50% LTV and mezzanine debt up to 75% increasing the total LTV % percentage to 80% may increase the mezzanine debt piece from 50-75% to 50-80% in the capital structure while maintaining the senior debt at its original 50% LTV level.

FIG. 10B illustrates the effect of executing a pan gesture 904 in the second capital event panel 408 while the LTV assumption is selected. Such a gesture causes the LTV balance at the time of the second capital event (e.g. sell date) to be increased or decreased. In some cases an upwards pan gesture may increase the LTV balance (e.g. decrease the amortization during the hold period) and a downward pan gesture may decrease the LTV balance (e.g. increase the applied amortization during the hold period). As shown in FIGS. 10A and 10B, amortization per annum and interest amount may be highlighted beneath the middle horizontal zero line to denote expenditure or outgoings.

In some cases, as shown in FIGS. 10A and 10B, the cash flow projection engine 104 may be configured to maintain graphic proportionality between all income and outgoing cash annual items. In particular, in some cases the maximum annual outgoing is kept in proportion with the maximum annual incoming amount. Similarly, all quarterly amounts may be proportionate for each respective annual column.

Once the selected capital assumption has been adjusted the method 500 proceeds to block 542 where the projected cash flow and the parent graphical user interface 402 are updated accordingly.

If at block 518 it was determined that the pan gesture was not performed in a capital event panel 406 or 408 then the method 500 proceeds to block 522 where it is determined whether the detected pan gesture was performed in the cash flow panel 404. If it is determined that the detected pan gesture was performed in the cash flow panel 404 then the method 500 proceeds to block 524 where investment item of the selected or active sub-period (e.g. year) is increased or decreased based on the direction of the pan gesture. Where a particular portion (e.g. quarter) of the sub-time period has not been actively selected using, for example, a tap gesture, a cash flow item of all portions (e.g. quarters) of the selected sub-period may be increased or decreased simultaneously.

The feature of the sub-period (e.g. year), or portion of the sub-period (e.g. quarter), that is adjusted may be based on where the pan gesture is executed in the cash flow panel 404. For example, in some cases, when the user makes an upward pan gesture (e.g. towards the top of the parent graphical user interface 402) above the zero line a miscellaneous annual income default cash flow item of the selected sub-period is increased; and when the user makes a downward pan gesture (e.g. towards the bottom of the parent graphical user interface 402) above the line the miscellaneous annual income default cash flow item of the selected sub-period is decreased. In another example, when the user makes an upward or downward pan gesture below the zero line, a miscellaneous cost cash flow item of the selected sub-period is increased or decreased. The amount of the increase or decrease may be based on the speed of the pan gesture (e.g. how quickly the user has moved their finger); the amount of the pan gesture (e.g. how far the user has moved their finger); and/or the number of times the pan gesture is executed.

If at block 522 it was determined that the detected pan gesture was not performed in the cash flow panel 404 then the method 500 proceeds back to block 504 where the parent graphical user interface waits for another gesture to be received.

At block 526, it is determined whether the detected gesture is a pinch gesture. The term “pinch gesture” is used herein to mean that the user has placed two fingers (or two gesture making objects) on the input device and has either moved their fingers together or apart while in contact with the input device. If the detected gesture has been identified as a pinch gesture, the method 500 proceed to block 528. If, however, the detected gesture was not identified as a pinch gesture, the method proceeds to block 532.

At block 528, it is determined whether the detected pinch gesture was performed in the cash flow panel 404. If it is determined that the detected pinch gesture was performed in the cash flow panel 404 then the method proceeds to block 530 where the hold period is expanded or contracted based on the direction and size of the pinch gesture. For example, in some cases where the user moves their fingers apart the hold period is expanded (e.g. one or more additional time periods (e.g. sub-periods or portions thereof) are added) and where the user moves their fingers together the hold period is contracted (e.g. one or more time periods (e.g. sub-periods or portions thereof) are removed).

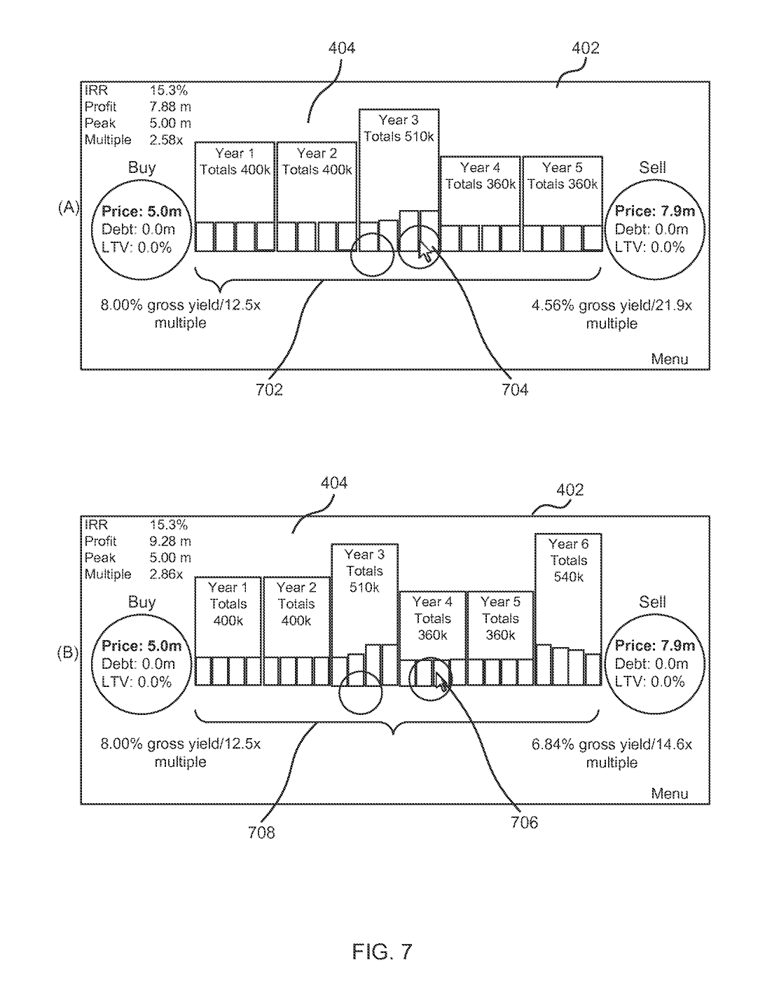

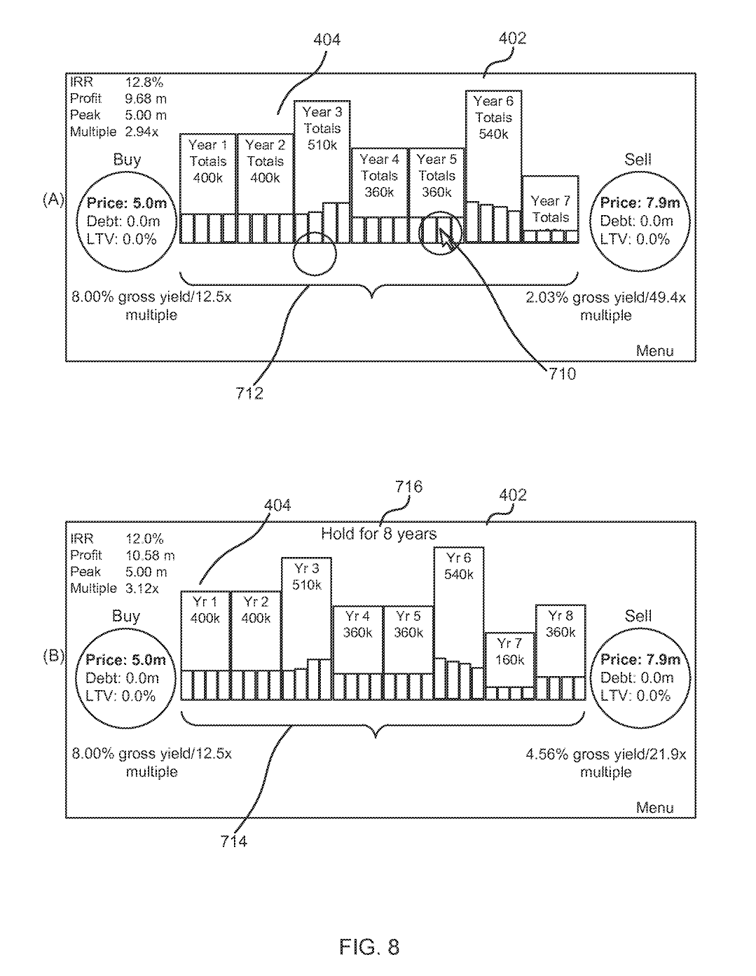

An example of a parent graphical user interface after performing a pinch gesture in the cash flow panel 404 is illustrated in FIGS. 7 and 8. In particular, FIG. 7A illustrates a parent graphical user interface 402 where the hold period 702 of the cash flow panel 404 is set to five years. The user then performs a pinch gesture in the cash flow panel 404 where they move their fingers from a first position 704 (FIG. 7A) to a second position 706 (FIG. 7B). This results in the hold period 708 expanding to 6 years (i.e. an additional sub-period (year) is added to the hold period). If the user continues to move their fingers further apart (e.g. from the second position 706 (FIG. 7B) to the third position 710 (FIG. 8A) the hold period 712 may be further expanded to 7 years (i.e. an additional sub-period (year) is added to the hold period). If the user continues to move their fingers apart they may reach a final hold period 714 of eight years (FIG. 8B).

As shown in FIGS. 7A, 7B, 8A and 8B the cash flow projection engine 104 may be configured to maintain graphic proportionality between the sub-periods and portions thereof (e.g. annual and quarterly amounts) as sub-periods (or portions thereof) are added or deleted. For example in FIG. 7A, the year three cash flow was the largest and tallest amount in the five year hold period, but in FIG. 7B the year six cash flow becomes the largest and tallest amount when it appears. Similarly, as more time periods appear, the descriptions of the time periods are adapted to fit the screen.

A notification message 716 may be displayed at the top of the cash flow panel 404 that indicates the change that has been made as a result of a gesture. For example, in FIG. 7D the message 716 indicates the hold period has been changed to 8 years. Although the notification message 716 is shown at the top of the parent graphical user interface 402 it will be evident to a person of skill in the art that it could be placed anywhere in the parent graphical interface 402.

In some cases, instead of, or in addition to displaying a message (e.g. message 716) after the user has adjusted the hold period (e.g. after completing a pinch gesture), a message may be displayed as soon as the user starts the gesture (e.g. pinch gesture) which is continuously updated as the user is making the gesture. For example, if a user starts executing a pinch gesture in the cash flow panel a message may be displayed indicating the new hold period as a result of the pinch gesture with the hold period value in the message changing as the pinching action evolves.

It is also noted that since the performance metrics are automatically updated after a change is made to the hold period, the user can quickly find the optimal hold period to maximize the time value of money committed to the investment.

If at bock 528, it is determined that the detected pinch gesture was not performed in the cash flow panel 404, the method 500 may proceed back to block 504 where the parent graphical user interface 402 waits to receive the next gesture.

At block 532, it is determined whether the detected gesture is a long press or a press and hold gesture. The terms “long press gesture” and “press and hold gesture” are used interchangeably herein to mean that the user has placed a finger (or other gesture making object, such as a stylus) on the input device and held it there for a predetermined minimum amount of time (e.g. >0.65 of a second). The predetermined minimum amount of time is used to distinguish a tap gesture from a long press gesture/press and hold gesture. If the detected gesture has been identified as a long press gesture, the method 500 proceeds to block 534. If, however, the detected gesture was not identified as a long press gesture, the method proceeds back to block 504 where the parent graphical user interface 402 waits for the next gesture input.

At block 534 it is determined whether the long press gesture was executed in the cash flow panel 404. If it is determined that the detected long press gesture was executed in the cash flow panel 404 then the method proceeds to block 536 where the graphical user interface is modified to display the child graphical user interface instead of the parent graphical user interface. As described above, the child graphical user interface allows the user to add or edit individual cash flow items to the projected cash flow. The method 500 then proceeds to block 542 where the projected cash flow, performance metrics and the parent graphical user interface 402 are updated accordingly

If at block 534 it is determined that the detected long press gesture was not executed in a cash flow panel 404 then the method 500 proceeds to block 538 where it is determined whether the detected long press gesture was executed in a capital event panel 406 or 408. If it is determined that the detected long press gesture was executed in a capital event panel 406 or 408 then the method 500 proceeds to block 540 where the user is provided with means (e.g. a touch number pad) to enter a numerical or alphanumerical value for the selected capital assumption. For example, where the user performs or executes a long press gesture in the first capital event panel 406 and the price assumption is currently selected or activated then a numerical keypad may appear in the parent graphical user interface 402 to allow the user to enter a specific numerical value for the price.

If at block 538 it was determined that the detected long press gesture was not executed in a capital event panel 406 or 408 then the method 500 proceeds back to block 504 where the parent graphical user interface 402 waits for the next gesture input.

Although method 500 describes sequentially assessing a detected gesture to determine if it is one of a plurality of gestures (e.g. is it gesture A?, if it is not gesture A, is it gesture B and so on), in other cases a detected gesture will be assessed once to determine the type of gesture and then what action to be taken in response to the gesture is determined based on the type of gesture assessed.

Reference is now made to FIG. 11 which illustrates an example child graphical user interface 1002. As described above, the child graphical user interface 1002 allows a user to add and/or edit individual cash flow items of the projected cash flow. The exemplary child graphical user interface 1002 of FIG. 11 is divided into three areas—a cash flow panel 1004 which displays a graphical representation of the projected cash flow over the hold period (the period between the first and second capital events); a first side panel 1006 for displaying new cash flow items and assumptions for existing cash flow items (i.e. cash flow items that are part of the projected cash flow) that can be selected and/or edited by the user; a second side panel 1008 for displaying the existing cash flow items. The child graphical user interface 1002 may also comprise an “Add item” button 1010 that allows a user to add new cash flow items to the projected cash flow and a “Hide panels” button 1012 that allows the user to hide the first and second side panels 1006 and 1008 to return the graphical user interface to the parent graphical user interface 402. It will be evident to the person of skill in the art that the label or text used herein to describe a button in a particular graphical user interface (e.g. “Hide panels” and “Add item” to describe buttons 1010 and 1012 respectively) is exemplary and any suitable label or text can be used to identify a button.

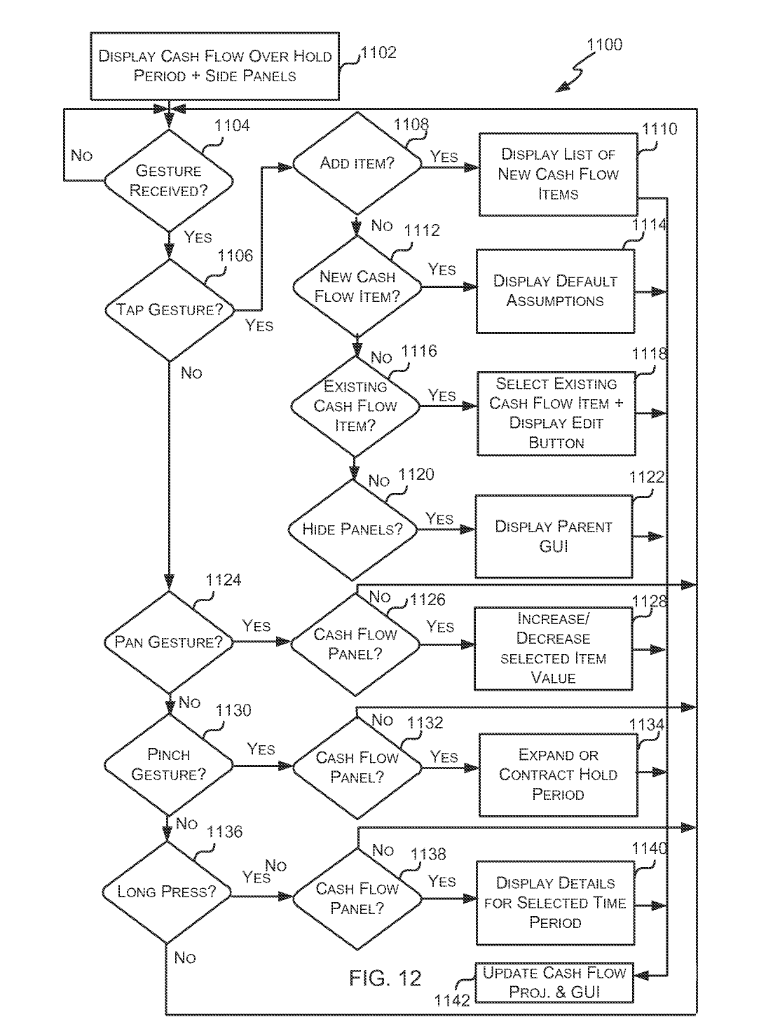

Reference is now made to FIG. 12 which illustrates a method 1100 for operating the child graphical user interface 1002 of FIG. 11. In particular, method 1100 illustrates an example of what gestures may be used/accepted in the child graphical interface 1002 to invoke changes to the projected cash flow. In this example, the child graphical user interface 1002 accepts tap, pan, pinch and press and hold touch gestures, however, it will be evident to a person of skill in the art that these are examples only and other suitable touch and other gestures may be used in the alternative or in addition.

At block 1102, the projected cash flow over the hold period is shown in the cash flow panel 1004 of the child graphical user interface 1002 and the first and second side panels 1106 and 1108 are displayed. In some cases the first and second side panels enter in an animated fashion. For example, they may appear to slide in from the sides of the graphical user interface 1002. Once the projected cash flow has been displayed for the current investment, the method 1100 proceeds to block 1104.

At block 1104, the child graphical user interface 1002 waits for the user to perform a touch and/or other gesture. Once the child graphical user interface 1002 has detected the user has performed a touch and/or other gesture, the method 1100 proceeds to block 1106.

At block 1106, it is determined whether the detected gesture is a tap gesture (as described above with reference to FIG. 5). If it is determined that the detected gesture is a tap gesture then the method proceeds to blocks 1108, 1112, 1116, and 1120 to determine if the tap gesture was performed on a relevant part of the child graphical user interface 1002.

At block 1108 it is determined whether the detected tap gesture was performed on the “Add Item” button 1010 indicating the user wishes to add a cash flow item. If it is determined that the detected tap gesture was performed on the “Add Item” button 1010 then the method 1100 proceeds to block 1110 where a list of new cash flow items that may be added are displayed in the first side panel 1006.

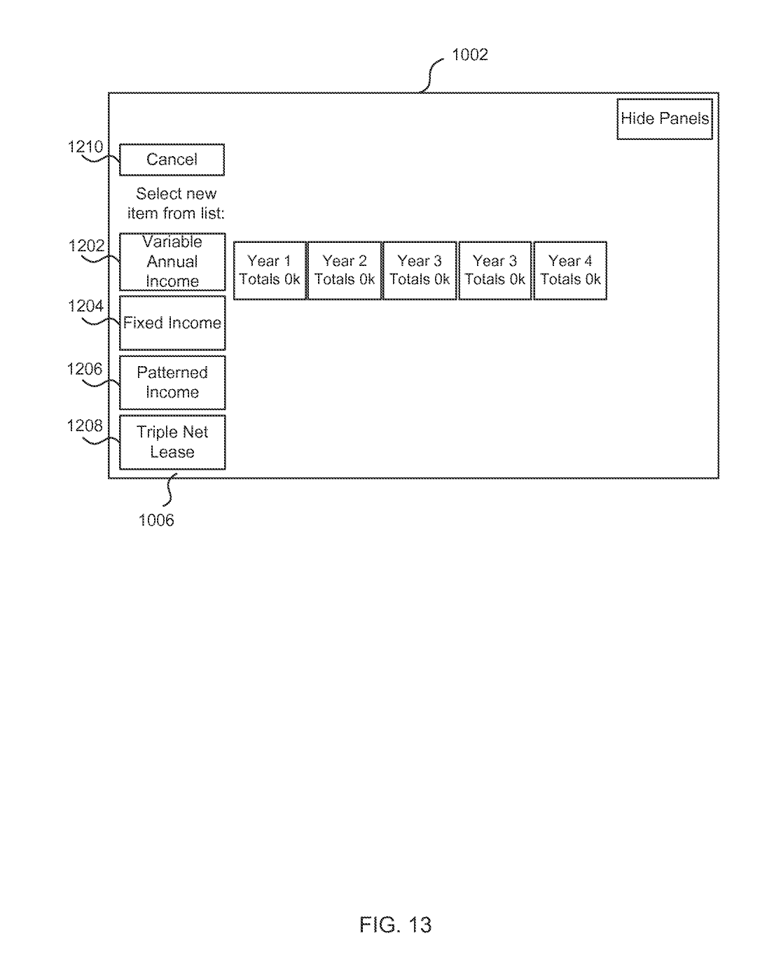

An example of the child graphical user interface 1002 after the user has performed a tap gesture on the “Add Item” button 1010 is shown in FIG. 13. It can be seen that the first side panel 1006 of the child graphical user interface 1002 has been updated with a list of new cash flow items 1202, 1204, 1206, 1208 that may be added to the projected cash flow. In the example shown in FIG. 13, the list includes the following new cash flow items that may be added: variable annual income 1202; fixed income 1204; patterned income 1206; and triple net lease 1208. It will be evident to a person of skill in the art that these new cash flow items are examples only and other or additional cash flow items may be listed.

In some cases the first side panel 1006 may also provide a link to additional cash flow items or may provide the user with sets of predefined cash flow items for particular investment types. For example, cash flow items may be packaged for industry sectors (e.g. real estate, manufacturing units for production lines, aircraft/vehicle leasing business proposals, gilt investment analysis, hedge fund investment, structures/options, private retail consumer banking saving products) which the user can select to install and/or remove. Some packages may also only be available on purchasing a subscription. For example, there may be a packaged set of cash flow items for mergers and acquisitions which may install two financial data series (for the respective companies to be merged) from standard investment-banking industry API linked to Factset and facilitate automation of clean merger and acquisition models to produce a cash flow projection for a merger proposition. This allows the user to customize the application for their specific needs and allows them to only view cash flow items that are relevant to them.

Once the user has selected the “Add Item” button the user may select one of the new cash flow items 1202, 1204, 1206 or 1208 (e.g. by executing a tap gesture over one of the new cash flow items 1202, 1204, 1206 or 1208); press a cancel button 1210 (e.g. by executing a tap gesture over the cancel button 1210) to remove the list of new cash flow items; or press the “Hide Panels” button (e.g. by executing a tap gesture over the Hide panels button) to return to the parent graphical user interface 402.

At block 1112 it is determined whether the detected tap gesture was executed on a new cash flow item to indicate selection of the new cash flow item (e.g. the user has selected a new cash flow item from the list of new cash flow items displayed after selecting the “Add Item” button 1010). If it is determined that the detected tap gesture was executed on a new cash flow item then the method 1100 proceeds to block 1114 where a list of default assumptions for the selected new cash flow item is displayed in the first side panel 1006.

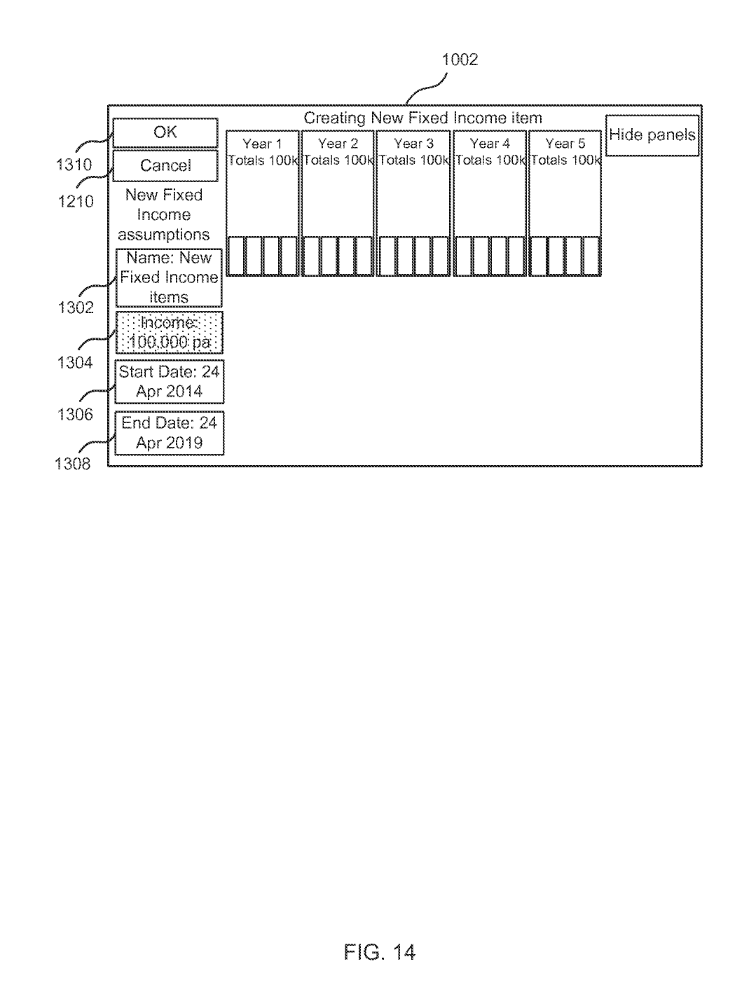

An example of the child graphical user interface 1002 after the user has performed a tap gesture on a listed new cash flow item is shown in FIG. 14. In particular, FIG. 14 shows the child graphical user interface 1002 after the user has performed a gap gesture on the “new fixed income” item of FIG. 13. It can be seen that the first side panel 1006 of the child graphical user interface 1002 has been updated with a list of default assumptions 1302, 1304, 1306 and 1308 for the selected new cash flow item (e.g. the new fixed income item). In the example shown in FIG. 14 the default assumptions include a name for the fixed income item 1302, the income per annum 1304; the start date 1306 and the end date 1308. Each of the default assumptions can be edited by performing a tap gesture on the assumption and then performing a subsequent gesture (e.g. a pan gesture) to adjust the value.

Once the user has selected a new cash flow item the user can either add the new cash flow item to the projected cash flow by selecting the “OK” button 1310 (e.g. performing a tap gesture on the OK button 1310) or the user can cancel the creation of the new cash flow item by selecting the “Cancel” button 1210 (e.g. performing a tap gesture on the Cancel button 1210). The user may also be able to cancel the creation of the new cash flow item by selecting the “Hide panels” button.

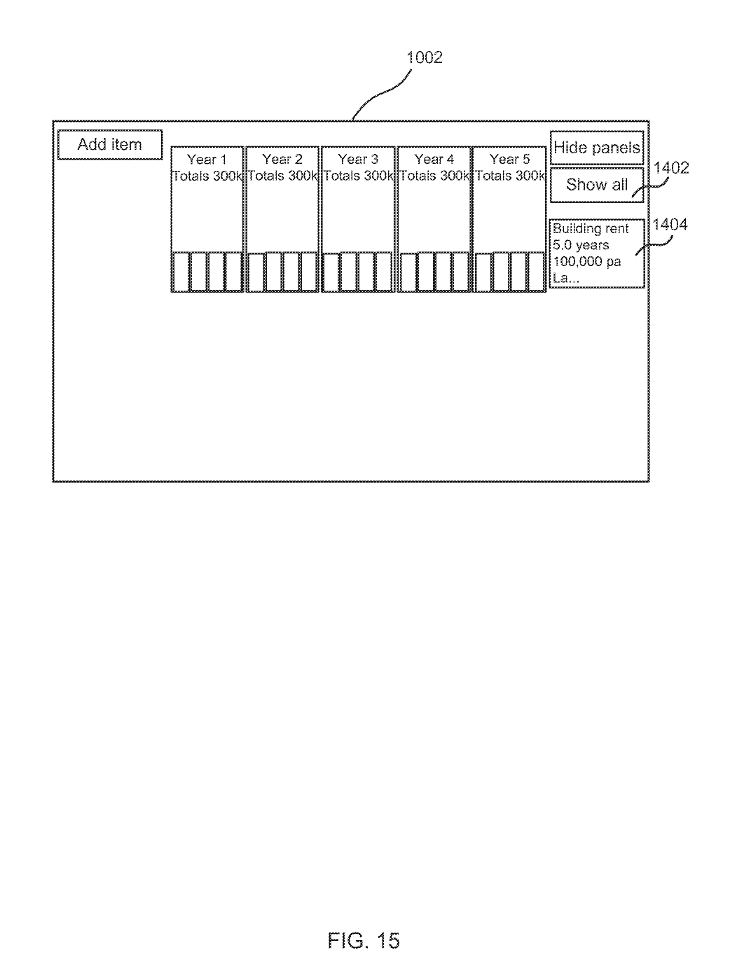

At block 1116 it is determined whether the detected tap gesture was executed on an existing cash flow item to indicate selection of the existing cash flow item (e.g. the user has selected an existing cash flow item to view/edit). For example, as shown in FIG. 15, if the projected cash flow comprises one or more cash flow items when the user activates the child graphical user interface 1002 then the second side panel 1008 of the child graphical user interface 1002 may display a list of the cash flow items 1404 that form the projected cash flow (i.e. the existing cash flow items).

Although FIG. 15 shows only one cash flow item, it will be evident to a person of skill in the art that more than one cash flow items may be displayed. Each cash flow item 1404 may be represented by a label that displays information about the cash flow item. The information displayed by the label may include, for example, assumptions related to the cash flow item or any other. In some cases the label may be implemented in an animated fashion so that more information may be displayed by the label. In particular, the label may be implemented in blinking and/or marquee fashion to show multiple pieces of information. For example, the label may alternate from showing the term of the cash flow item (e.g. 10.7 years) and the expiry date (e.g. April 2025).

If it is determined that the detected tap gesture was executed on an existing cash flow item (e.g. cash flow item 1404 of FIG. 15) then the method 1100 proceeds to block 1118 where the first side panel 1006 is updated to show an “Edit” button allowing the user to edit the selected cash flow item and the cash flow panel 1004 is updated to highlight the part of the projected cash flow that is associated with the selected cash flow item.

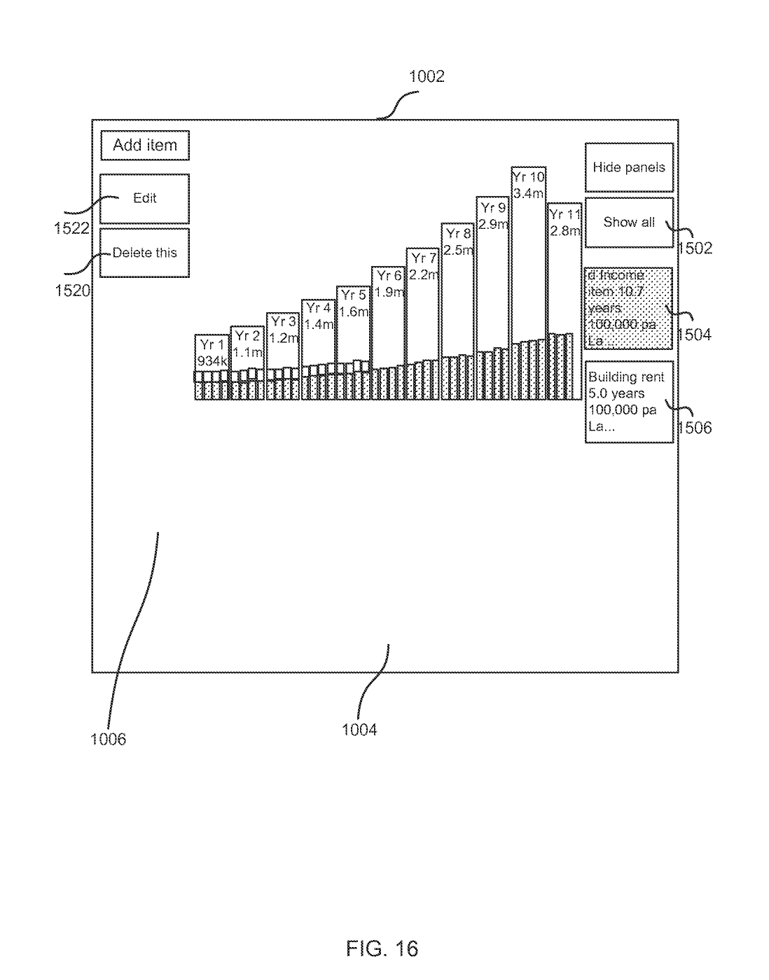

An example of the child graphical user interface 1002 after the user has performed a tap gesture on an existing cash flow item is shown in FIG. 16. In particular, FIG. 16 shows the child graphical user interface 1002 after the user has performed a tap gesture on the patterned income item 1504. It can be seen that the first side panel 1006 has been updated to show an “Edit” button 1522 and a “Delete this” button 1520 and the cash flow panel 1004 has been updated to highlight the part of the projected cash flow that is associated with or attributed to the selected cash flow item. If the user selects the “Delete this” button 1520 (e.g. by performing a tap gesture on the button 1520) then the cash flow data 203 and the database 206 are updated to remove this cash flow item. If, however, the user selects the “Edit” button 1522 (e.g. by performing a tap gesture on the button 1522) then the child graphical user interface 1002 is updated to allow editing of the selected cash flow item.

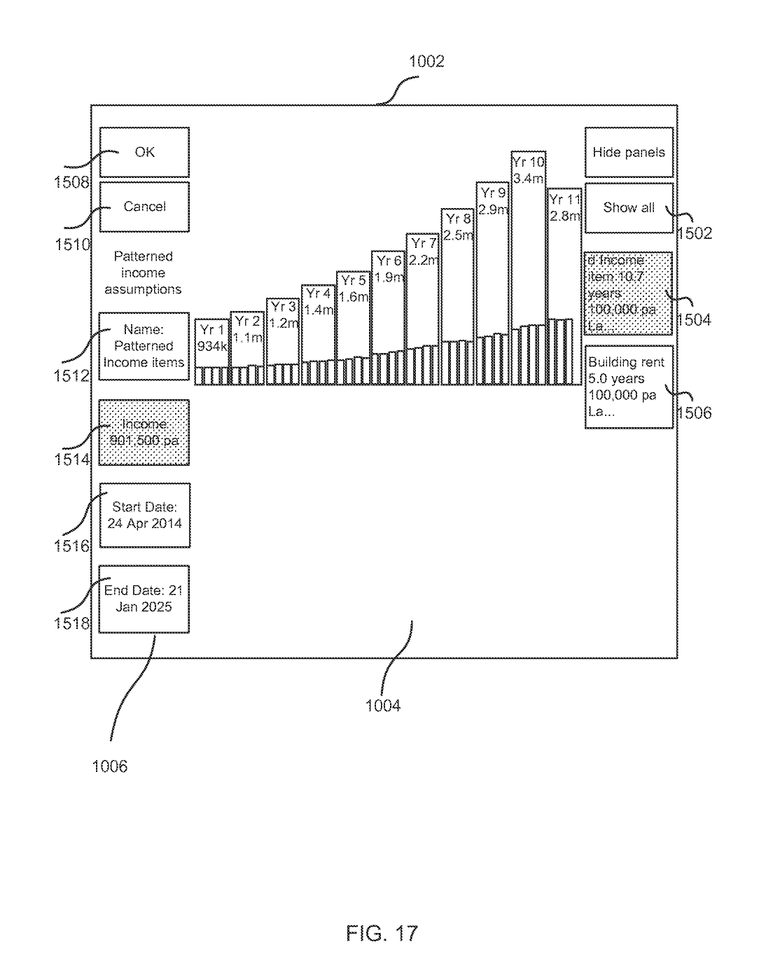

In particular, FIG. 17 shows an example of the child graphical user interface after the user has selected the “Edit” button 1520. It can be seen that the first side panel 1006 has been updated to show the assumptions 1512, 1514, 1516 and 1518 associated with the selected pattern income item 1504 and the cash flow panel 1004 has been updated to only display the projected cash flow associated with the patterned income item 1504. In the example shown in FIG. 17, the assumptions associated with the patterned income item 1504 include the name of the item 1512; income per annum 1514; start date 1516 and end date 1518. It would be evident to a person of skill in the art these assumptions are examples only and additional or other assumptions may be used based on the particular cash flow item type.

The user may edit any of the assumptions 1512, 1514, 1516, and 1518 by selecting the assumption 1512, 1514, 1516 or 1518 (e.g. by performing a tap gesture on the assumption) and then performing a subsequent gesture (e.g. a pan gesture) to adjust the assumption. Any changes may then be saved by selecting the OK button 1508 (e.g. by performing a tap gesture on top of the OK button 1508) or cancelled by selecting the cancel button 1510 (e.g. by performing a tap gesture on top of the Cancel button 1510).

At block 1120, it is determined whether the detected tap gesture was performed on the “hide panels” button 1012. If it was determined that the detected tap gesture was performed on the “hide panels” button 1012 the method proceeds to block 1122 where the graphical user interface is converted back to the parent graphical user interface 402 configuration (e.g. FIG. 4).

Although, it is not explicitly shown in method 1100 of FIG. 12, the method may comprise further steps to determine if the detected tap gesture was executed in any other significant part of the child parent screen 1002. For example, as described above the method may comprise (a) determining if the detected tap gesture is executed on an OK button 1310 or 1508 to cause any changes to the selected cash flow item to be saved to the projected cash flow (e.g. saved in the database); (b) determining if the detected tap gesture is executed on a Cancel button 1210 or 1510 to cause any changes to the selected cash flow item to be discarded (e.g. they are not saved to the projected cash flow and/or database); (c) determining if the detected tap gesture is executed on a Show All button 1402 or 1502 to cause all of the cash flow items forming the projected cash flow to be displayed in the second side panel 1008; (d) determining if the detected tap gesture is executed on Delete item button 1520 to cause the selected cash flow item to be deleted from the projected cash flow and/or database; (e) determining if the detected tap gesture is executed in the Edit button 1522 to cause the assumptions associated with the selected cash flow item to be displayed; and/or (f) determining if the detected tap gesture is executed in the cash flow panel 1004 to cause information about the corresponding sub-period (or portion thereof) of the cash flow to be displayed, as described with reference to FIG. 5 and the parent graphical user interface 402. It will be evident to a person of skill in art that these are examples and that actions may be caused by performing a tap gesture in another area of the child graphical user interface 1002.

At block 1124 it is determined whether the detected gesture was a pan gesture (as described above with reference to FIG. 5). If it was determined that the detected gesture was not a pan gesture then the method 1100 proceeds to block 1130. If it was determined that the detected gesture was a pan gesture then the method proceeds to block 1126 where it is determined whether the detected pan gesture was executed in the cash flow panel 1004. If it was determined that the detected pan gesture was executed in the cash flow panel 1004 then the method 1100 proceeds to block 1128 where any selected cash flow item assumption is decreased or increased. For example, a pan gesture made toward the top part of the child graphical user interface 1002 may cause the selected cash flow item assumption (e.g. income per annum 1304) to be increased; and a pan gesture made toward the bottom part of the child graphical user interface 1002 may cause the selected cash flow item assumption (e.g. income per annum 1304) to be decreased. The amount of the increase or decrease may be based on the speed at which the gesture was performed (e.g. how quickly the user has moved their fingers); the amount of the pan gesture (e.g. the distance the user's finger (or other gesture object) is moved during the gesture); and/or the number of times the user performed the gesture.

At block 1130 it is determined whether the detected gesture was a pinch gesture (as described above with reference to FIG. 5). If it was determined that the detected gesture was not a pinch gesture then the method 1100 proceeds to block 1136. If, however, it was determined that the detected gesture was a pinch gesture then the method 1100 proceeds to block 1132 where it is determined whether the pinch gesture was performed in the cash flow panel 1004. If it was determined that the pinch gesture was performed in the cash flow panel 1004 then the method 1100 proceeds to block 1134 where the hold period is expanded or contracted in a similar manner to that described with respect to the parent graphical user interface 402. For example, in some case performing a pinch gesture that brings the user's fingers (or other gesture objects) together may cause the hold period to be reduced or contracted and similarly performing a pinch gesture that pushes the user's fingers (or other gesture objects) apart may cause the hold period to be expanded.

At block 1136 it is determined whether the detected gesture was a long press (as described above with reference to FIG. 5). If it was determined that the detected gesture was not a long press gesture then the method 1100 proceeds back to block 1104 where the child graphical user interface 1002 waits for the next gesture input. If, however, it was determined that the detected gesture was a long press gesture then the method proceeds to block 1138 where it is determined whether the detected long press gesture was performed in the cash flow panel 1004. If it was determined that the detected long press gesture was performed in the cash flow panel 1004 then the method proceeds to block 1140 where the details for the sub-period corresponding to the long press gesture are displayed.

In some cases, if it is determined that the detected long press gesture was not performed in the cash flow panel 1004 then it is determined whether the long press gesture was performed on an assumption in the first side panel 1006. If it is determined that a long press was performed on an assumption in the first side panel 1006 then an additional window may be displayed which allows the user to manually enter a specific value or text for the assumption. The additional window may comprise a number pad, a calendar date selection tool, and/or a text field that allows alphanumeric inputs from a keyboard or other input device.

After each change caused by execution of a gesture (e.g. after blocks 1110, 1114, 1118, 1122, 1128, 1134, 1140) the method 1100 proceeds to block 1142 where the projected cash flow, performance metrics and the parent graphical user interface 402 are updated accordingly.

Although the graphical user interface has been described above as comprising a single parent graphical user interface 402 and a single child graphical user interface 1002, in other cases there may be multiple levels of the parent graphical user interfaces 402 which can be used to display and interact with different levels of the investment. For example, where an investment relates to a portfolio of assets, the graphical user interface may comprise a top or high level parent graphical user interface that displays and allows interaction with the projected cash flow for the portfolio as a whole. The top or high level parent graphical interface may then provide a mechanism (e.g. a button or set of buttons) to allow the user to go to a lower level parent graphical user interface, such as graphical user interface 402 described above, which displays the projected cash flow of a specific asset within the portfolio.

Although the example graphical user interfaces (e.g. graphical user interfaces 402 and 1002) are described as being controlled by touch gestures, it will be evident that other gestures and input may also be used to control the graphical user interface and the projected cash flow associated therewith. For example, instead of selecting the “Add item” button by executing a tap gesture on the Add item button, the user may have the ability to create a new cash flow item (when the child graphical user interface 1002 is displayed) by verbally saying the name of the cash flow item. For example, the user may be able to create a new lease item, new fixed income item, or new patterned income item by stating “new lease”, “new fixed income” or “new patterned income”.

The user may be able to set up an entirely new property cash flow verbally which may be a shortcut to set-up a number of new leases. For example, the user could say “create new property with a total 10,000 square foot with twelve leases with a total rent of $300,000 per annum expiring in 2022.” The cash flow projection engine 104 may interpret this by populating the cash flow data 203 with 12 new lease items, each with a fixed income of $25,000 ($25K×12=300,000) until an expiry date of 2022 and a designated area of 833.333 square feet (833×12=10,000 sq ft) amount to $30 per square foot of contracted rent.

Such a shortcut for creating multiple leases may be useful for analysts and investors who constantly look at, for example, office towers in the US in major central business districts. In particular, it can be very cumbersome and tedious to create and set-up a stacking plan in a spreadsheet to consider a real estate investment. For example, a 36-floor office building in New York can have a known total rent per annum, but an analyst then needs to model different estimated rental values per square foot across higher premium floors down to lower floors with no view (or between floors that have had different degrees of refurbishment). With such a shortcut, a new model could be created in seconds and the projected cash flow would have the equivalent of 36 floors and allow the user to change assumptions for each lease assumption which represents a single floor.

FIG. 18 illustrates various components of an exemplary computing-based device 1600 which may be implemented as any form of a computing and/or electronic device, and in which embodiments of the methods and systems described herein may be implemented.

Computing-based device 1600 comprises one or more processors 1602 which may be microprocessors, controllers or any other suitable type of processors for processing computer executable instructions to control the operation of the device in order to generate a projected cash flow for an investment from touch and/or other gesture inputs. In some examples, for example where a system on a chip architecture is used, the processors 1602 may include one or more fixed function blocks (also referred to as accelerators) which implement a part of the method of generating a cash flow projection for an investment from touch and/or other gesture inputs in hardware (rather than software or firmware). Platform software comprising an operating system 1604 or any other suitable platform software may be provided at the computing-based device to enable application software 1604 to be executed on the device, such as a cash flow projection engine 104 as described above.

The computer executable instructions may be provided using any computer-readable media that is accessible by computing based device 1600. Computer-readable media may include, for example, computer storage media such as memory 1606 and communications media. Computer storage media (i.e. non-transitory machine readable media), such as memory 1606, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 1606) is shown within the computing-based device 1600 it will be appreciated that the storage may be distributed or located remotely and accessed via a network or other communication link (e.g. using communication interface 1608).

The computing-based device 1600 also comprises an input/output controller 1610 arranged to output display information to a display device 1612 which may be separate from or integral to the computing-based device 1600. The display information may provide a graphical user interface. The input/output controller 1610 is also arranged to receive and process input from one or more devices, such as a user input device 1614 (e.g. a mouse or a keyboard). This user input may be used by the cash flow projection engine 104 to generate a projected cash flow for an investment. In an embodiment the display device 1612 may also act as the user input device 1614 if it is a touch sensitive display device. The input/output controller 1610 may also output data to devices other than the display device, e.g. a locally connected printing device (not shown in FIG. 18).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A dynamically updating prediction system, the system comprising a computing-based device comprising:
a cash flow data object implemented by the computing-based device, the cash flow data object comprising one or more cash flow items forming an investment;
a cash flow projection module implemented by the computing-based device, the cash flow projection module in communication with the cash flow data object, the cash flow projection module configured to:
generate a projected cash flow for the investment based on the cash flow data object, and
generate one or more performance metrics for the investment based on the projected cash flow; and
a visual controller module implemented by the computing-based device, the visual controller module in communication with the cash flow projection module, the visual controller module configured to:
generate a graphical representation of the projected cash flow and display the graphical representation of the projected cash flow in a graphical user interface,
display the one or more performance metrics for the investment in the graphical user interface,
receive a gesture input from the user via the graphical user interface, wherein the gesture input includes a type of gesture and a location of the gesture, and
provide the gesture input to the cash flow projection module;
wherein the cash flow projection module is further configured to update the projected cash flow and the one or more performance metrics for the investment based on the gesture input.

2. The system of claim 1, wherein each cash flow item comprises one or more assumptions.

3. The system of claim 1, wherein the gesture input is a touch gesture.

4. The system of claim 3, wherein the type of touch gesture is one of a pan gesture, a pinch gesture, a tap gesture and a long press gesture.

5. The system of claim 1, further comprising a spreadsheet generation module configured to generate a cash flow spreadsheet representing the projected cash flow.

6. The system of claim 5, wherein generating the cash flow spreadsheet comprises generating a formula for use in at least one cell of the spreadsheet and generating a current value for the at least one cell.

7. The system of claim 1, wherein the graphical user interface comprises a parent graphical user interface and a child graphical user interface, the parent graphical user interface configured to display the graphical representation of the projected cash flow, and the child graphical user interface configured to allow the user to edit the cash flow items.

8. The system of claim 7, wherein the parent graphical user interface comprises a cash flow panel configured to display the graphical representation of the projected cash flow, a first capital event panel configured to display one or more first capital event assumptions, and a second capital event panel configured to display one or more second capital event assumptions.

9. The system of claim 8, wherein the cash flow panel is situated between the first capital event panel and the second capital event panel.

10. The system of claim 7, wherein the child graphical user interface comprises a cash flow panel configured to display the graphical representation of the projected cash flow, a second side panel configured to display one or more cash flow items forming the projected cash flow, and a first side panel configured to display assumptions associated with a selected one of the cash flow items displayed in the second side panel.

11. The system of claim 10, wherein the first side panel is further configured to display one or more new cash flow items, each new cash flow item being selectable for addition to the projected cash flow.

12. The system of claim 1, further comprising an input module configured to receive verbal input from the user at the computing-based device; and the cash flow projection module is further configured to update the projected cash flow based on the verbal input.

13. The system of claim 1, wherein the graphical representation of the projected cash flow is a bar graph.

14. The system of claim 1, the computing-based device being at least partially implemented using hardware logic selected from any one or more of: a field-programmable gate array, a program-specific integrated circuit, a program-specific standard product, a system-on-a chip, a complex programmable logic device.

15. The system of claim 1, wherein the computing-based device is one of a smart phone and a tablet computer comprising a touchscreen.

16. A computer-implemented method for dynamically updating a prediction, the method comprising:
generating, at a computing-based device, a graphical representation of a projected cash flow of an investment over a period of time;
generating, at the computing-based device, one or more performance metrics for the investment based on the projected cash flow;
displaying the graphical representation of the projected cash flow and the one or more performance metrics in a graphical user interface;
receiving gesture input from a user via the graphical user interface indicating an adjustment to the projected cash flow wherein the gesture input includes a type of gesture and a location of the gesture;
dynamically adjusting, at the computing-based device, the projected cash flow based on the gesture input received from the user;
dynamically adjusting, at the computing-based device, the one or more performance metrics based on the adjusted projected cash flow; and
updating the graphical user interface to reflect the adjusted projected cash flow and the one or more performance metrics.

17. A tangible computer-readable media with device-executable instructions that, when executed by a computing-based device, direct the computing-based device to perform steps comprising:
generating a graphical representation of a projected cash flow of an investment over a period of time;
generating one or more performance metrics for the investment based on the projected cash flow;
displaying the graphical representation of the projected cash flow and the one or more performance metrics in a graphical user interface;
receiving gesture input from a user via the graphical user interface indicating an adjustment to the projected cash flow wherein the gesture input includes a type of gesture and a location of the gesture;
dynamically adjusting the projected cash flow based on the gesture input received from the user;
dynamically adjusting the one or more performance metrics based on the adjusted projected cash flow; and
updating the graphical user interface to reflect the adjusted projected cash flow and the adjusted one or more performance metrics.

18. The system of claim 1, wherein the type of touch gesture is one of a pan gesture, a pinch gesture, a tap gesture and a long press gesture;
wherein the location of the gesture is one of a capital event panel and a cash flow panel; and
wherein the cash flow projection module is further configured to update the projected cash flow and the one or more performance metrics for the investment based on the combination of the type of touch gesture and the location of the gesture.

19. The computer-implemented method of claim 16, wherein the type of touch gesture is one of a pan gesture, a pinch gesture, a tap gesture and a long press gesture;
wherein the location of the gesture is one of a capital event panel and a cash flow panel; and
wherein the projected cash flow and the one or more performance metrics for the investment are dynamically adjusted based on the combination of the type of touch gesture and the location of the gesture.

20. The tangible computer-readable media of claim 17, wherein the type of touch gesture is one of a pan gesture, a pinch gesture, a tap gesture and a long press gesture;
wherein the location of the gesture is one of a capital event panel and a cash flow panel; and
wherein the projected cash flow and the one or more performance metrics for the investment are dynamically adjusted based on the combination of the type of touch gesture and the location of the gesture.
